(19) United States
(12) Patent Application Publication
(10) Pub. No.: US 2026/0016449 A1
(43) Pub. Date: Jan. 15, 2026

(54) STRUCTURAL HEALTH MONITORING SENSOR AND SYSTEM

(71) Applicant: The University of Adelaide, Adelaide (AU)

(72) Inventors: Nouné Sophie Melkoumian, Dover Gardens (AU); Stanley Donald Woithe, Fulham Gardens (AU); Yien Lik Kuo, Glenunga (AU); Ian George Cates, Golden Grove (AU)

(21) Appl. No.: 18/994,540

(22) PCT Filed: Jul. 12, 2023
(86) PCT No.: PCT/AU2023/050643

§ 371 Date: Jan. 14, 2025

(30) Foreign Application Priority Data
Jul. 15, 2022 (AU) 2022901989

(51) Int. Cl. G01N 29/24; G01N 29/34; G01N 29/44

(52) U.S. Cl. CPC G01N 29/2437; G01N 29/2475; G01N 29/348; G01N 29/4436; G01N 2291/012; G01N 2291/018; G01N 2291/0258

(57) ABSTRACT

A structural health monitoring system comprises frequency sweep generator which generates an AC which is simultaneously provided to multiple impedance measuring circuit modules. Each impedance measuring circuit module is connected to a piezoelectric transducer (PZT) which is placed on or embedded within the structure to be monitored. The impedance measuring circuit modules are each configured to generate two output signals. The first signal is a voltage proportional to the phase difference between the input sweep signal and the PZT current signal and the second signal is a voltage proportional to the current through the PZT. A data acquisition module digitises the signals and generates an estimate of the real component of the (complex) impedance across the PZT at the sweep frequency. The sweep generator is configured to generate multiple sweep signals each at a different frequency over a sweep frequency range to generate an impedance spectrum which can be used to detect structural changes such as cracking.

### PRIORITY DOCUMENTS

The present application claims priority from Australian Provisional Patent Application No. 2022901989 titled “STRUCTURAL HEALTH MONITORING SENSOR AND SYSTEM” and filed on 15 Jul. 2022, the content of which is hereby incorporated by reference in its entirety.

### TECHNICAL FIELD

The present disclosure relates to systems for monitoring structures and materials. In a particular form the present disclosure relates to a monitoring system for monitoring structural health and material condition (including condition of soils) for integrity, damage including environmental, cracks and fracture development in various materials, machinery, pressure vessels, infrastructure, including mining and civil structures, etc.

### BACKGROUND OF THE INVENTION

In the mining, oil and gas, geotechnical, mechanical, civil engineering and infrastructure sectors it is necessary to regularly inspect structures and materials for crack initiation, crack activation and damage, for a variety of safety and economic reasons. Traditionally inspections have been carried out manually by inspectors that visually inspect structures. This manual approach is time consuming and allow for human error and inaccuracy. In some settings, visual inspections are simply impossible. Thus, in recent years various technological solutions have been investigated for performing structural health monitoring by use of X-ray radiography, optical fibres, ultrasonic and vibration based systems. However, these systems have a number of deficiencies, such as high cost, large size and weight, limited usability on a wide range of structures and/or require skilled operators.

One approach has proposed the use of piezoelectric transducers, also known as piezoelectric sensors, placed on or embedded in structures for long term continuous or periodic/repeated monitoring. Piezoelectric transducers (PZT) comprise a small patch or wafer of a piezoelectric material such as a piezoceramic to which two wires are connected. Piezoelectric materials have the property that they generate an electrical charge when stressed mechanically and it has been shown that the electrical impedance of the PZT is directly related to the mechanical impedance of the host structure on which it is placed. They potentially enable long term continuous monitoring of the host structure's mechanical properties by measuring the electrical impedance of the PZT over a range of frequencies-typically in the range of 30-400 kHz. Detecting a change in the electrical impedance signature can be considered an indication of a change in the structural integrity such as the sign of a crack, damage or weakening of a structural member such as a bolt. However, impedance is a complex quantity and thus requires specialised circuits to measure. One approach was to use an impedance analyser such as a HP4194A to directly measure the complex impedance across a PZT. However, these impedance analysers are large making any monitoring system bulky. Further the analysers were designed for use in a laboratory and thus were not robust or suited to permanent field deployment.

A few researchers have proposed alternatives to the use of expensive impedance analyser. One approach has been to place a PZT in series with a resistor and measuring the voltage across the resistor (e.g., modelled on a voltage divider arrangement). The impedance in the PZT was then approximated as the voltage across the resistor over the current through the resistor. An issue with this approach was that it only approximated the impedance across the PZT and could generate large errors. Thus, another approach proposed using a calibrated resistor whose resistance is known to high precision so that a more accurate impedance measurement could be obtained. This required measuring the voltage across the PZT and the voltage across the calibrated resistor. However, to avoid the need for the use of expensive differential probes, the voltage across the PZT was indirectly measured by subtracting the voltage across the calibrated resistor from the input voltage signal from the frequency generator (Alternating Current (AC) source). Additionally, to avoid having to actually measure the phase angle, an FFT based method was used in which an FFT was performed on the input and signals across the calibrated resistor to obtain an estimate of the amplitude and phase of impedance across the PZT. Impedance spectra obtained using the system can be compared with a reference spectrum to detect changes indicative of damage or cracks. Another variation suggested the source AC signal was a linear chirp signal. Another variation was to measure the RMS current in the resistor along with the average power consumed by the PZT. Whilst the average power is dependent upon phase angle, a direct measurement of phase angle is not required. Instead, a precision high speed analog multiplier was used to obtain the power as a function of time and this signal was provided to a low pass filter which provided a Direct Current (DC) value representative of the average power. The RMS current was obtained by measuring the shunt voltage across the resistor, and using the known voltage of the resistor, converting to a DC value using an RMS-to-DC converter. From these measurements a microcontroller is used to determine the resistance which is the average power over the square of the RMS current. The process is repeated for multiple frequencies. However, none of these proposed approaches have had much commercial success or been widely adopted. This may be due to a lack of robustness or due to limitations such as requiring sequential or dedicated measurements of each PZT acting as a barrier to large scale deployment or scale up, as well as the large size of the equipment, high costs, and the inability to read from a large number of sensors simultaneously.

Another approach has proposed the use two PZTs-the first configured to act as an actuator (stimulation source) and the second as a sensor (as a receiver)-to detect Lamb (or Rayleigh-Lamb) waves which are elastic waves that propagate over the surface of the structure. A stimulus signal delivering device delivers a waveform signal to the stimulator PZT to generate an acoustic signal in the substrate on which it is mounted. A second PZT located a distance from the stimulator PZT is then used as a receiver. The two outputs of the receiver PZT are provided to differential amplifier which generates an amplified version of the signal across the PZT. A second amplifier stage with a controllable gain is used to produce a signal in 0-3 V range which is provided to an ADC to provide a measure of the magnitude of the signal. The process can be repeated for multiple receivers in different locations and over multiple frequencies. The digitised signals can then be analysed by a program on a computer to detect changes in the structure. The device can also be used to perform electrochemical impedance spectroscopy to obtain impedance as a function of frequency and observed spectral curves can be compared with reference curves. However, a limitation of this system is that by using a Lamb wave based measurement the system is only useful for monitoring of surface conditions and is less reliable for detecting body cracks and damage. Further reading from multiple sensors using this approach is complicated and requires extensive data analysis.

To date there are few commercial systems for structural health monitoring and those that exist are typically expensive and require complex equipment or are subject to other limitations of applications (e.g., specific structures). Whilst PZT based systems have great potential, prior art systems remain expensive and cannot presently be applied to many real structures such as bridges which are often large and comprise many components or sections and are often subjected to a range of complex forces. There is thus a need to provide improved structural health monitoring systems and circuits suitable for large scale deployment, or to at least provide a useful alternative to existing structural health monitoring systems.

### SUMMARY OF THE INVENTION

According to a first aspect, there is provided an impedance measuring circuit comprising:
a buffer configured to receive an Alternating Current (AC) sweep signal from a frequency sweep generator and provide the buffered sweep signal to an input of a piezoelectric sensor;
a current to voltage converter in parallel with a feedback resistor configured such that the current to voltage converter and feedback resistor receive a piezoelectric output signal from the piezoelectric sensor and to generate a piezoelectric current signal in which the AC voltage is proportional to both the phase angle and the current through the piezoelectric sensor;
a phase comparison circuit which receives the buffered sweep signal on a first input and the piezoelectric current signal on a second input and is configured to compare the piezoelectric current signal with the buffered sweep signal and generates an output piezoelectric phase signal having a Direct Current (DC) voltage proportional to the phase difference between the buffered sweep signal and the piezoelectric current signal;
a rectifier circuit which receives the piezoelectric current signal on a first input and is configured to generate an output piezoelectric current signal having a DC voltage proportional to the current through the piezoelectric sensor.

In one form, the phase comparison circuit comprises:
a digital phase detector which receives the buffered sweep signal on a first input and the piezoelectric current signal from the current to voltage converter on a second input and is configured to compare the piezoelectric current signal with the buffered sweep signal and generate a first piezoelectric phase signal; and
a first low pass filter configured to receive the first piezoelectric phase signal and generate the output piezoelectric phase signal having a DC voltage proportional to the phase difference between the buffered sweep signal and the piezoelectric current signal; and the rectifier circuit comprises:
a rectifier configured to receive the piezoelectric current signal on a first input and rectify the piezoelectric current signal to generate a first piezoelectric current signal; and
a second low pass filter configured to receive the first piezoelectric current signal and generate the output piezoelectric current signal having a DC voltage proportional to the current through the piezoelectric sensor.

In one form, the AC sweep signal has a frequency in the range from 5 kHz to 1 MHz and the components of the circuit are configured to operate over the frequency range from 5 kHz to 1 MHz.

In one form, the output piezoelectric phase signal and the output piezoelectric current signals are DC signals with a voltage in the range of 0V to 5V. In one embodiment a phase signal of 4.2V represents a phase shift of 90 degrees.

In one form, the impedance measuring circuit consumes less than 5 Watts of power.

According to a second aspect, there is provided a multi sensor impedance measuring circuit module comprising:
a sweep signal input connector configured to receive an input AC sweep signal or sweep generator circuit configured to generate an AC sweep signal;
a voltage converter circuit configured to generate a plurality of regulated supply voltages from an input supply voltage connector;
a plurality of impedance measuring circuit modules according to the first aspect wherein the sweep signal input is provided as input to each of the impedance measuring circuits;
a plurality of a paired input connectors for connecting to an input and an output of a piezoelectric sensor wherein each paired input connectors are connected to one of the plurality of impedance measuring circuit modules; and
a plurality of paired output connectors each connected to the output of one of the impedance measuring circuit modules wherein the paired outputs comprise the output piezoelectric phase signal and the output piezoelectric current signal from the respective impedance measuring circuit module;

In one form, the voltage converter circuit is configured to generate a regulated +5V supply, a −5V supply, and a +3V supply.

In a further form, the impedance measuring circuit further comprises a compact small-size housing which houses a circuit board comprising a plurality of surface mounted components which implement one or more components of the multi sensor impedance measuring circuit module. In a further form the circuit board has a first dimension of 38 mm or less and a second dimension of 55 m or less.

According to a third aspect, there is provided a structural health monitoring circuit module for use in a structural health monitoring system.

In one form the structural health monitoring circuit comprises:
one or more multi-sensor impedance measuring circuit modules according to the second aspect wherein the one or more multi-sensor impedance measuring circuit module comprises the power supply circuit and the sweep signal generator wherein the power supply circuit comprises a voltage regulator configured to receive an unregulated voltage supply in the range of 9V to 18V (nominally 12V) and a regulated +5V, +3V and −5V supply; and
a user interface, at least one processor and at least one memory, wherein the user interface is configured to receive one or more user input signals which are provided to the at least one processor for configuring the structural health monitoring circuit module including configuring the sweep generator circuit wherein the one or more user input signals are either received using an input device and/or from a remote device.

In an alternative form, the structural health monitoring circuit is for connection to one or more multi-sensor impedance measuring circuit modules according to the second aspect wherein the one or more multi-sensor impedance measuring circuit modules comprise the input supply voltage connector and the sweep signal input connector, and the structural health monitoring circuit module comprises:
a power supply circuit comprising a voltage regulator configured to receive an unregulated voltage supply in the range of 9V to 18V (nominally 12V) and a regulated +5V, +3V and −5V supply;
a power output connector for providing the unregulated voltage supply over a wired connector to the input voltage supply connector of the one or more multi-sensor impedance measuring circuit modules;
a sweep generator circuit configured to generate an AC sweep signal;
a sweep signal output connector for providing the AC sweep signal over a wired connector to the sweep signal input connector of the one or more multi-sensor impedance measuring circuit modules; and
a user interface, at least one processor and at least one memory, wherein the user interface, is configured to receive user input signals which are provided to the at least one processor for configuring the structural health monitoring circuit module including configuring the sweep generator circuit wherein the user input signals are either received using an input device or are received from a remote device. In some embodiments the user interface may be a touch screen.

In one form, the AC sweep signal has a frequency in the range from 5 kHz to 1 MHz.

In one form, the AC sweep signal has an RMS voltage of (nominally) 200 mV or less. In one form the sweep generator circuit may also generate a trigger signal.

In one form, the structural health monitoring module further comprises an analog to digital converter circuit configured to convert each output piezoelectric phase signal and each output piezoelectric current signal from each of the one or more multi-sensor impedance measuring circuit modules into a digital representation comprised of a digitised phase signal and a digitised current signal, wherein the one or more processors are configured to analyse the digital representations and estimate a real impedance as a function of frequency for each sensor and generate and store a monitoring report in the at least one memory, and a communications module configured to allow sending or downloading of a stored monitoring report.

In one form, the at least one memory is configured to store a recipient address, and one or more alert trigger conditions for generating an alert, and the one or more processors are configured to analyse the digitised phase signal and the digitised current signal for each of the one or more multi-sensor impedance measuring circuit modules to determine if one or more of the one or more alert trigger conditions are satisfied, and the communications module is a wireless communications module configured to send the monitoring report to a recipient address and/or an alert to a recipient if one or more of the one or more alert trigger conditions are satisfied. The recipient address may be a cloud data storage location, a server address, an email address, and mobile phone number or other electronic address.

In one form, the one or more user input signals are received from the remote device via the communications module, or from the user interface, and the one or more user input signals comprises one or more of a frequency range of the sweep generator circuit, a signal level, one or more monitoring parameters, one or more alert trigger conditions and/or one or more recipient addresses. In one form the input device comprises a touch screen and is configured to allow the user to input one or more of a frequency range of the sweep generator circuit, a signal level and one or more monitoring parameters such as a scan rate. The user interface may also allow a user to input or configure one or more alert trigger conditions and/or one or more recipient addresses. In one form the one or more monitoring parameters configure the microprocessor to monitor a predefined group of one or more impedance measuring circuits. In some embodiments each group comprises two or more impedance measuring circuits located on a portion of the structure to be monitored. In some embodiments each impedance measuring circuit in the group is proximal (or near) to each other to enable sectional or spatial monitoring of the structure.

In one form analysing the digitised phase signal and the digitised current signal for each of the one or more multi-sensor impedance measuring circuit modules comprises estimating a real impedance, Zᵣₑₐₗ=V_{cos}(θ)/I where θ is the respective digitised phase signal and I is the respective digitised current signal, and V is a predetermined constant obtained from a calibration measurement comprising measuring an input voltage across the respective piezoelectric sensor.

According to a fourth aspect, there is provided a structural health monitoring system comprising:
a structural health monitoring circuit module according to the third aspect;
one or more multi-sensor impedance measuring circuit modules according to the second aspect;
a data acquisition module comprising an analog to digital converter circuit, at least one processor, at least one memory and a communications module, wherein the analog to digital converter circuit is configured to convert each output piezoelectric phase signal and each output piezoelectric current signal from each of the one or more multi-sensor impedance measuring circuit modules into a digital representation comprised of a digitised phase signal and a digitised current signal, and the at least one processor is configured to analyse the digital representations estimate a real impedance as a function of frequency for each sensor and generate and store a monitoring report in the at least one memory, and the communications module is configured to allow sending or downloading of the stored monitoring report.

In one form, the at least one memory is configured to store a recipient address, and one or more alert trigger conditions for generating an alert, and the one or more processors are configured to analyse the digitised phase signal and the digitised current signal for each of the one or more multi-sensor impedance measuring circuit modules to determine if one or more of the one or more alert trigger conditions are satisfied, and the communications module is a wireless communications module configured to send the monitoring report to a recipient address and/or an alert to a recipient if one or more of the one or more alert trigger conditions are satisfied.

In one form, the one or more user input signals are received from the remote device via the communications module or from the user interface, and the one or more user input signals comprises one or more of a frequency range of the sweep generator circuit, a signal level, one or more monitoring parameters, one or more alert trigger conditions and/or one or more recipient addresses. In a further form the one or more monitoring parameters are used to configure the one or more processors to monitor a predefined group of one or more impedance measuring circuits.

In one form analysing the digitised phase signal and the digitised current signal for each of the one or more multi-sensor impedance measuring circuit modules comprises estimating a real impedance, Zᵣₑₐₗ=V_{cos}(θ)/I where θ is the respective digitised phase signal and I is the respective digitised current signal, and V is a predetermined constant obtained from a calibration measurement comprising measuring an input voltage across the respective piezoelectric sensor.

According to a fifth aspect, there is provided a method for measuring the impedance of a piezoelectric sensor, comprising:
buffering an Alternating Current (AC) sweep signal received from a frequency sweep generator and providing the buffered sweep signal to an input of a piezoelectric sensor;
generating a piezoelectric current signal in which the AC voltage is proportional to both the phase angle and the current through the piezoelectric sensor using a current to voltage converter in parallel with a feedback resistor configured such that the current to voltage converter and feedback resistor receive a piezoelectric output signal from the piezoelectric sensor;
generating an output piezoelectric phase signal having a Direct Current (DC) voltage proportional to the phase difference between the buffered sweep signal and the piezoelectric current signal using a phase comparison circuit which receives the buffered sweep signal on a first input and the piezoelectric current signal on a second input and is configured to compare the piezoelectric current signal with the buffered sweep signal and;
generating an output piezoelectric current signal having a DC voltage proportional to the current through the piezoelectric sensor using a rectifier circuit which receives the piezoelectric current signal on a first input.

In one form, the method further comprises digitising the output piezoelectric phase signal to obtain a digitised phase signal θ and digitising the output piezoelectric current signal to obtain a digitised current signal I, and estimating a real impedance, Zᵣₑₐₗ=V_{cos}(θ)/I where V is a predetermined constant obtained from a calibration measurement comprising measuring an input voltage across the piezoelectric sensor.

### BRIEF DESCRIPTION OF DRAWINGS

Embodiments of the present disclosure will be discussed with reference to the accompanying drawings wherein:

FIG. 1A is a schematic diagram of a structural health monitoring system according to an embodiment;

FIG. 1B is a schematic diagram of an impedance measuring circuit module of the structural health monitoring system according to an embodiment;

FIG. 2 is a schematic diagram of a modularised distributed structural health monitoring system according to an embodiment;

FIG. 3A is wiring diagram of a structural health monitoring system comprising a sweep generator and a first multi-sensor module according to an embodiment;

FIG. 3B is a circuit diagram of a first part of a first impedance measuring module of the first multi sensor module of FIG. 3A;

FIG. 3C is a circuit diagram of a first part of a second impedance measuring module of the first multi sensor module of FIG. 3A;

FIG. 3D is a circuit diagram of a first part of a third impedance measuring module of the first multi sensor module of FIG. 3A;

FIG. 3E is a circuit diagram of a first part of a fourth impedance measuring module of the first multi sensor module of FIG. 3A;

FIG. 3F is a circuit diagram of a second part of the first and second impedance measuring modules of the first multi sensor module of FIG. 3A;

FIG. 3G is a circuit diagram of a second part of the third and fourth impedance measuring modules of the first multi sensor module of FIG. 3A;

FIG. 3H is wiring diagram of a structural health monitoring system comprising a sweep generator, a first multi-sensor module and a second multi-sensor module according to an embodiment;

FIG. 4A is a plot of the real impedance as a function of frequency of a piezoelectric sensor embedded in a first location in a mortar joint under a range of loads generated by a structural health monitoring system according to an embodiment;

FIG. 4B is a plot of the real impedance as a function of frequency of a second piezoelectric sensor embedded in a second location in a mortar joint under a range of loads generated by a structural health monitoring system according to an embodiment;

FIG. 5A is a schematic illustration of a brick wall formed of bricks and mortar joints indicating the approximate locations of five piezoelectric sensors according to an embodiment;

FIG. 5B is a bar plot of damage index as a function of increasing loads for five piezoelectric sensors located on a brick surface of the wall as illustrated in FIG. 5A according to an embodiment;

FIG. 5C is a bar plot of damage index as a function of increasing loads for five piezoelectric sensors embedded in a mortar joint in the wall as illustrated in FIG. 5A according to an embodiment;

FIG. 5D is a bar plot of damage index as a function of increasing loads for five piezoelectric sensors located on a mortar joint surface of the wall as illustrated in FIG. 5A according to an embodiment; and

FIG. 6 is a plot of the real impedance as a function of frequency for two piezoelectric sensors located on a steel plate through which a bolt is loosely screwed into a steel beam (first plot) and when the bolt which is tightly screwed into the steel beam (second plot), generated by a structural health monitoring system according to an embodiment.

In the following description, like reference characters designate like or corresponding parts throughout the figures.

### DESCRIPTION OF THE INVENTION

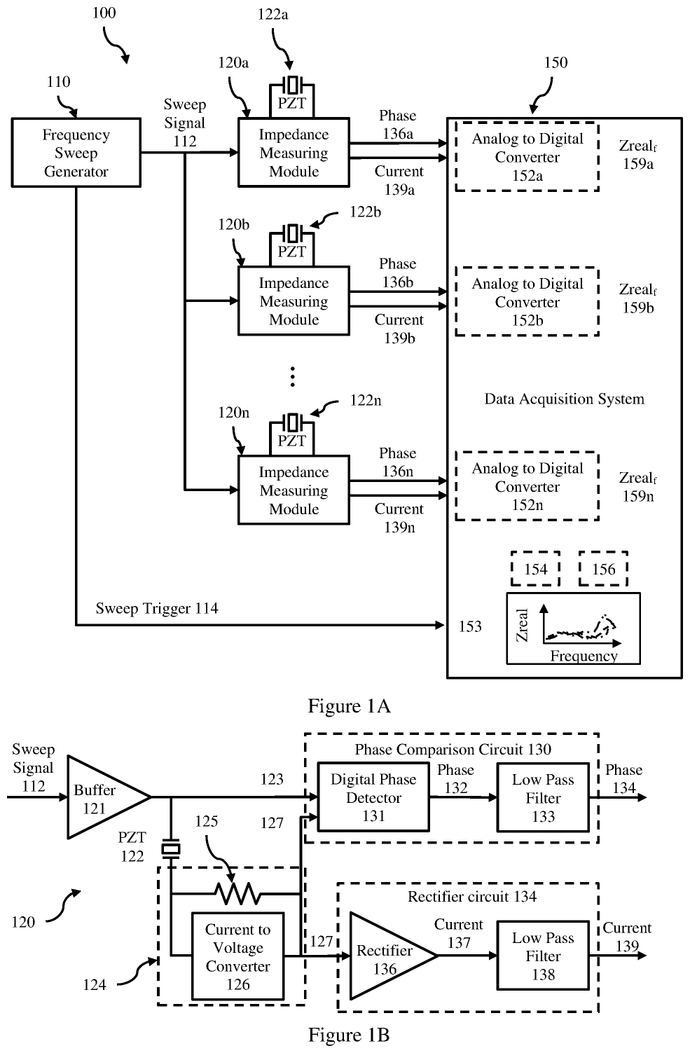

Referring now to FIG. 1A, there is shown a structural health monitoring system 1 according to an embodiment. The system comprises a frequency sweep generator 110 which generates an Alternating Current (AC) sweep signal 112 and a sweep trigger signal 114. The sweep signal is an AC signal at a particular sweep frequency which is simultaneously provided to multiple (N) impedance measuring circuit modules 120. Each impedance measuring circuit module 120 is connected to a piezoelectric sensor 122, also referred to as a piezoelectric transducer or PZT, which is placed on or embedded within the structure to be monitored (with each PZT in a different location). In some embodiments the system could comprise a single impedance measuring circuit module 120, but in most typical structural monitoring applications, the structure will be monitored in multiple locations by multiple impedance measuring circuit module 120 and associated PZTs, each at a different location on the structure. The sweep signal 112 is applied as an input to each impedance measuring circuit module 120, and to the associated PZT 122, and generates two output measurements with the first output being a phase signal 136 and the second output being a current signal 139. The phase signal 136 is a Direct Current (DC) signal having a voltage proportional or representative of the phase difference across the PZT and the current signal 139 is a DC signal having a voltage proportional or representative of the current through the PZT.

As shown in FIG. 1A, the sweep signal 112 is simultaneously provided to the N impedance measuring modules (120a, 120b, . . . 120n) which generate N phase signals (136a, 136b, 136n) and N current signals (139a, 139b, 139n) which are provided as input to a Data Acquisition System (DAQ) 150. The DAQ comprises one or more Analog to Digital Converter (ADC) circuits 152 which is used to convert each of the phase 136 and current 139 signal associated with a specific PZT into digital representations which are then analysed by a processor 154 and memory 156 configured to generate an estimate of the real component of the (complex) impedance across the PZT at the sweep frequency (Zreal_{f}). As shown in Figure IA, the DAQ may comprise N ADCs circuits (152a, 152b, 152n)-that is a dedicated ADC for each impedance measuring modules and PZT (e.g., a 1:1 relationship) to generate N estimates of the real component of the (complex) impedance across each of the N PZTs (159a, 159b, . . . , 159n). However, it will be understood that in other embodiments other ADC circuit arrangements could be used for example using digital multiplexing to enable digitisation of all N phase 136 and current signals 139. The analysis by the DAQ may be used to generate a monitoring report and/or an alert to a recipient. In some embodiments the DAQ may include a wireless communication module.

The sweep generator is configured to generate multiple sweep signals each at a different frequency (f) over a sweep frequency range, for example from 5 kHz. up to 1 MHz or more. At each sweep frequency the sweep signal is simultaneously provided to each impedance measuring module 120 and associated PZT 122 and an output phase 136 and current 139 used to generate an estimate of the real component of the impedance in the PZT 159 at the sweep frequency (Zreal_{f}). By generating multiple sweep signals over the sweep frequency range (each at a different frequency), an impedance spectrum can be generated, which is illustrated in FIG. 1A as a plot of the real impedance as a function of (sweep) frequency 153.

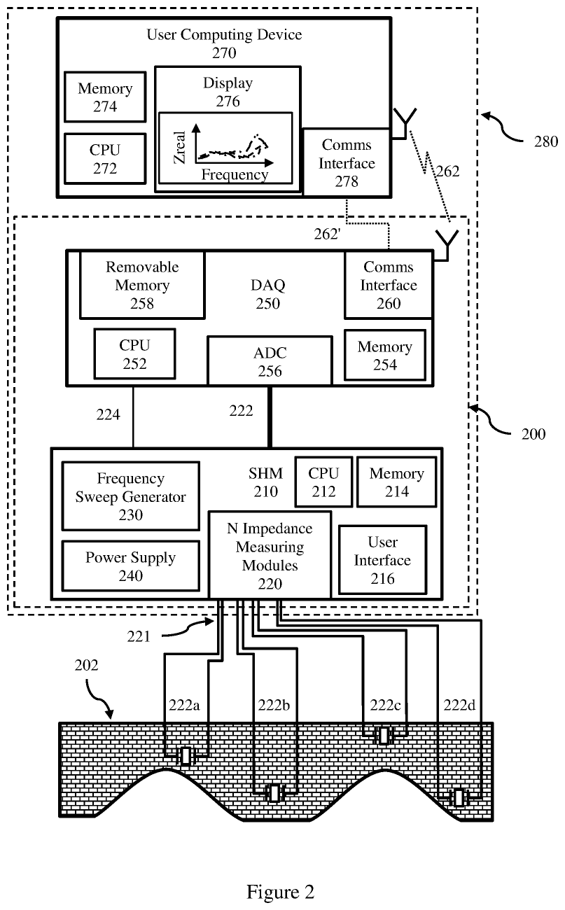

In this embodiment a sweep trigger signal 114 is also provided by the frequency sweep generator 110 to the DAQ 150 and is used to trigger processing of the received signals, for example to trigger the ADCs 152 to digitise the received phase 136 and current 139 signals. The frequency sweep generator generates multiple sweep signals each with a different frequency over the sweep frequency range. The sweep trigger may generate a trigger signal at the start of each different sweep signal (e.g., frequency) in the sweep frequency range. In other embodiments the sweep frequency generator may be configured to sweep across the sweep frequency range in a predetermined sampling pattern which is also known (e.g., stored) by the DAQ, such that only a single sweep trigger is generated at the start of a sweep (or sweep pattern). The predetermined pattern could be a predefined interval at a predefined sampling frequency, such as 1 kHz, 5 kHz or 10 kHz increment from a start frequency, at a sampling frequency of 1 kHz (i.e., one sample interval every one millisecond) until a stop frequency is reached. In other embodiments the predetermined pattern could be a set of predefined frequencies between the start and stop frequency with each frequency changed according to the sampling frequency. The sweep trigger signal 114 is a signal used by the data acquisition system (DAQ) 150 to trigger processing of received signals. In other embodiments such as that shown in FIG. 2, digitising of the received phase 136 and current 139 signals are performed by one or more ADC circuits co-located with or operatively connected to the frequency sweep generator and the trigger signal is used to trigger the ADC circuits. Alternatively, the ADC circuits could monitor their inputs and generate digitised signals on detection of an input signal omitting the need for a trigger signal 114, or a microprocessor could control the frequency sweep generator and ADC circuits such that a sweep trigger signal is not required. That is the sweep trigger signal is optional depending upon the specifics of the implementation.

A schematic diagram of an embodiment of an impedance measuring circuit module 120 is shown in FIG. 1B and comprises a buffer 121, a current to voltage converter module 124, a phase comparison circuit 130 and a rectifier circuit 134. The buffer 121 is configured to receive the AC sweep signal 112 from the frequency sweep generator 110 and provides the buffered sweep signal to an input of a piezoelectric sensor/transducer PZT 122. The current to voltage converter module 124 is located on the output side of the PZT 122 and comprises a current to voltage converter 126 in parallel with a feedback resistor 125 and are configured such that the current to voltage converter 126 and feedback resistor 122 receive a piezoelectric output signal from the PZT 122 and generate a piezoelectric current signal in which the AC voltage is proportional to both the phase angle and the current through the piezoelectric sensor 127. The piezoelectric current signal could alternatively be referred to as a piezoelectric voltage signal, as it is the output of the current to voltage converter. However, for the following discussion we will use piezoelectric current signal as it has a voltage proportional to the current generated by the piezoelectric sensor. In one embodiment the output signal of the PZT 122 (or signal across the PZT) is provided to the negative input of the current to voltage (I-V) converter 126 and the output of the I-V converter 126 adjusts to a voltage that maintains an equal but opposite current through the feedback resistor 125 to balance the PZT current. The phase comparison circuit 130 receives the buffered sweep signal 123 on a first input and the piezoelectric current signal 127 on a second input and is configured to compare the piezoelectric current signal with the buffered sweep signal and generate an output piezoelectric phase signal 134 having a DC voltage proportional to the phase difference between the buffered sweep signal and the piezoelectric current signal. The rectifier circuit receives the piezoelectric current signal 127 on a first input and is configured to generate an output piezoelectric phase signal 139 having a DC voltage proportional to the current through the PZT 122.

In one embodiment the phase comparison circuit 130 comprises a digital phase detector 131 which receives the buffered sweep signal 123 on a first input and the piezoelectric current signal 127 from the current to voltage converter on a second input and is configured to compare the piezoelectric current signal with the buffered sweep signal and generate a first piezoelectric phase signal 132. A first low pass filter 133 is configured to receive the first piezoelectric phase signal 132 and generate the output piezoelectric phase signal 134 having a DC voltage proportional to the phase difference between the buffered sweep signal and the piezoelectric current signal. In one embodiment the rectifier circuit comprises a rectifier 136 configured to receive the piezoelectric current signal 127 on a first input and rectify the piezoelectric current signal to generate a first piezoelectric current signal 137. A second low pass filter 138 is configured to receive the first piezoelectric current signal 137 and generate the output piezoelectric current signal 139 having a DC voltage proportional to the current through the piezoelectric sensor. The first and second low pass filters may be single pole low pass filters, although other multi-pole filters could be used. The low pass filters may be active filters or passive filters.

As noted above the AC sweep signal has a frequency in the range from 5 kHz to 1 MHz and the components of the circuit are configured to operate over that frequency range. That is, they are rated to operate over that frequency range with known consistent performance (e.g., linear or at least known stable response). In some embodiment the output piezoelectric phase signal and the output piezoelectric current signal are DC signals with a voltage in the range of 0 to 5V. In one embodiment a phase signal of 4.2V represents a phase shift of 90 degrees. In one form, the impedance measuring circuit consumes less than 5 Watts (or less than 5 Watts per four PZT sensor module).

The use of a buffer (or buffer amplifier) 121 on the input acts to isolate each impedance measuring circuit 120 from other impedance measuring circuits and ensures that all PZTs (and impedance measuring circuits) received the sample amplitude sweep signal without interfering with each other. This enables simultaneous operation (stimulation) of all N impedance measuring circuits 120 in the system 100 from the one sweep signal. That is at a particular sweep frequency all N impedance measuring circuits 120 operate in parallel. This allows simultaneous monitoring of the entire structure. This parallel operation speeds up the monitoring process as the limiting factor is the time taken to sweep across the sweep frequency range. As noted above the sampling frequency may be of the order of 1 kHz (i.e., one sample per millisecond) allowing the entire structure to be monitored over the frequency range in around 1 second or less (depending upon the number of separate sweep frequencies generated).

FIG. 2 is a schematic diagram of a modularised distributed structural health monitoring system 200 according to an embodiment. In this embodiment the system 200 comprises a structural health monitoring circuit module 210 for monitoring a structure 202, and a data acquisition module (DAQ) 250 for digitising and analysing the data generated by the structural health monitoring circuit module 210210 and for sending the reports or alerts to a user computing device 270.

The structural health monitoring system 200 may be provided as a single integrated module in a single housing comprising both the structural health monitoring circuit module 210 and the DAQ 250. or the system is comprised of multiple modules each in their own housing connected by a wired or wireless link. That is, in some embodiments the structural health monitoring circuit module 210 is provided in a first housing and the DAQ 250 is provided in a second housings (i.e., two separate physical modules) and the two modules/housings are connected by one or more cables which provide the output phase 134 and current 139 signals from the impedance measuring module 220 to the DAQ 250 for processing and storage. In one embodiment the structural health monitoring circuit module 210 is an integrated module and comprises one or more multi-sensor impedance measuring circuit modules 220 which comprise multiple impedance measuring circuit modules 120 as shown in FIG. 1B. The structural health monitoring circuit module 210 also comprises a frequency sweep generator 230, and a power supply circuit 240. The structural health monitoring circuit module 210 may also include a processor device comprising a CPU 212 and a memory 214, such as a microprocessor unit (MPU) or microcontroller, and a user interface 254 configured to receive user input signals for configuring the structural health monitoring circuit module 210 including configuring the sweep generator circuit 210. The structural health monitoring circuit module 210 is connected to a Data Acquisition Module (DAQ) 250 comprising an ADC 256 which receives the output phase 136 and current 139 signals from the impedance measuring circuit module 220 over cable 222 and digitises the input signals. The DAQ 250 further comprises a processor device comprising a CPU 252 and a memory 254. such as a microprocessor unit (MPU) or microcontroller. The microprocessor may comprise an on-board memory (e.g., RAM 254) and/or it may be connected to additional memory including removable memory 258 such as an SD card used to store programs and or store data. The trigger signal 114 is provided to the processor device (e.g., CPU 252) over cable 224 to trigger digitisation of the output signals of the impedance measuring circuit module 220 by the ADC 256. The digitised signals are stored in memory 254 and may be written to removable memory 258 in a datafile along with additional data such as time stamp and meta data relating to the measurements such as configuration of the frequency sweep generator and ADC configuration. The removable memory 258 may also be used to store software modules for generating data files such as formatting of the files and capturing of date, time and configuration parameters of the structural health monitoring circuit 210 (e.g., frequency ranges) and ADC 256 (sampling rate etc). A communications module 260 is also provided to send data to a user computing device 270 for further analysis and display. In some embodiment the communications module is a wireless communications module. The user computing device 270 is configured to analyse and/or display the data collected by the structural health monitoring circuit module 210 and processed by the DAQ 250, and comprises one or more CPUs 272 and memories 274, a display device 276 for displaying result (e.g., plots of Zᵣₑₐₗ vs frequency), and a communications interface 278 configured to receive data from the DAQ 250. The two respective communications interfaces 260 and 278 may communicate over a wireless link 262 or a wired link 262′. In some embodiments the system 200 may be provided as a fully integrated system 280 comprising the structural health monitoring circuit module 210, DAQ 250, and the user computing device 270. The user computing device 270 may be a general purpose computing device such as a mobile phone, tablet, laptop or desktop computer which executes software for analysis and/or display of data received from the DAQ 250. In the case of an integrated system (e.g., combined structural health monitoring circuit module 210 and the DAQ 250), a single microprocessor may be used to provide processing and memory for both the structural health monitoring module 210 and DAQ 250. That is DAQ CPU 252 and memory 254 may be provided by the CPU 212 and memory 214 of the structural health monitoring module. Further multiple microprocessors may be used in both the structural health monitoring module and DAQ to control different functions (ADC control, user interface, data storage, data transmission).

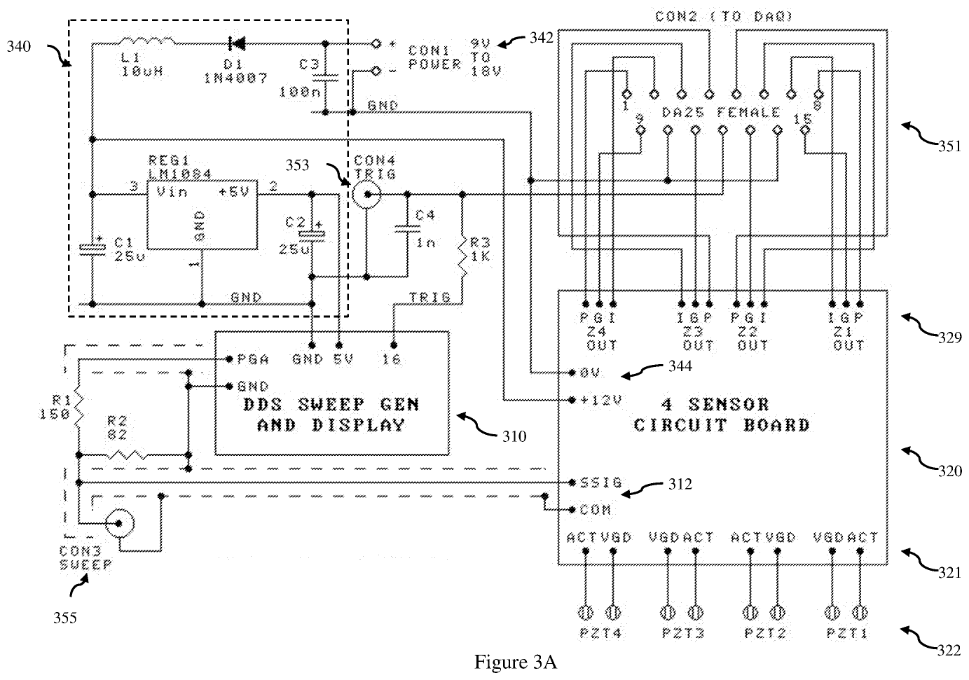

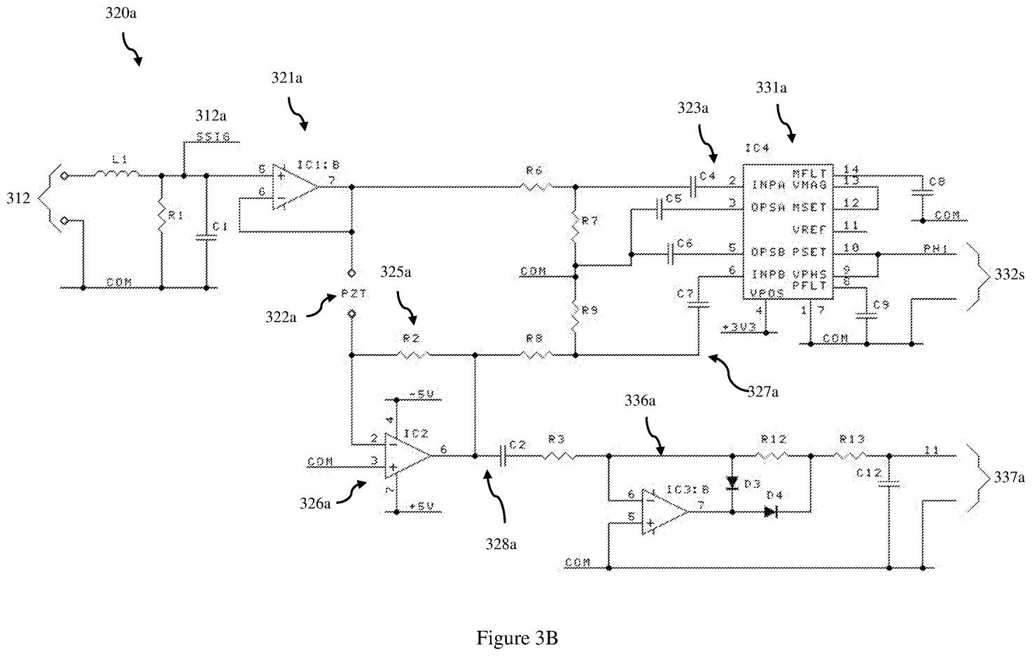

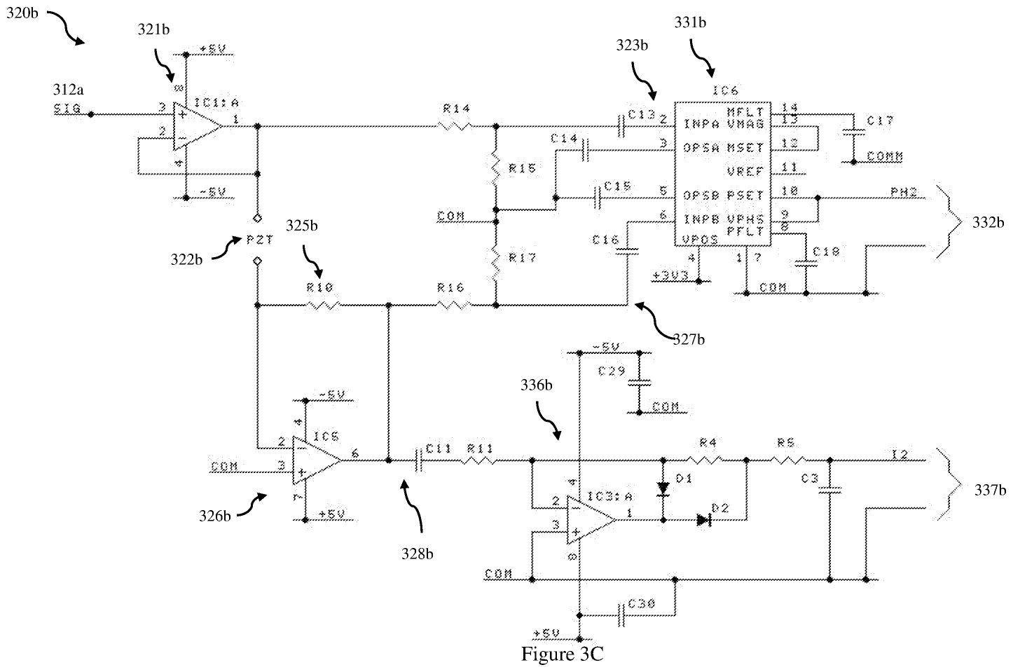

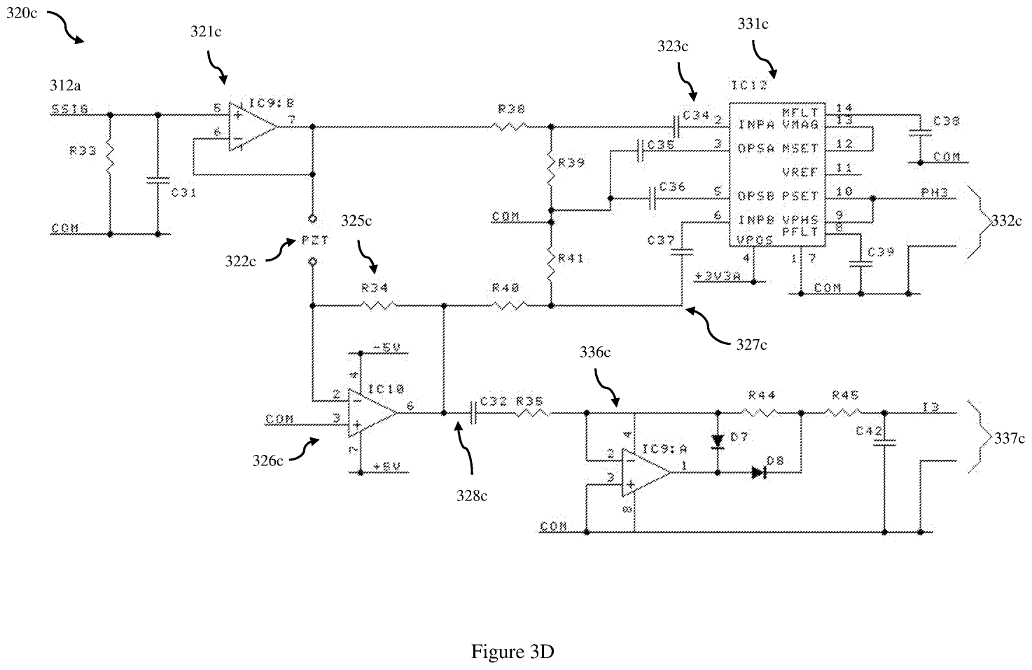

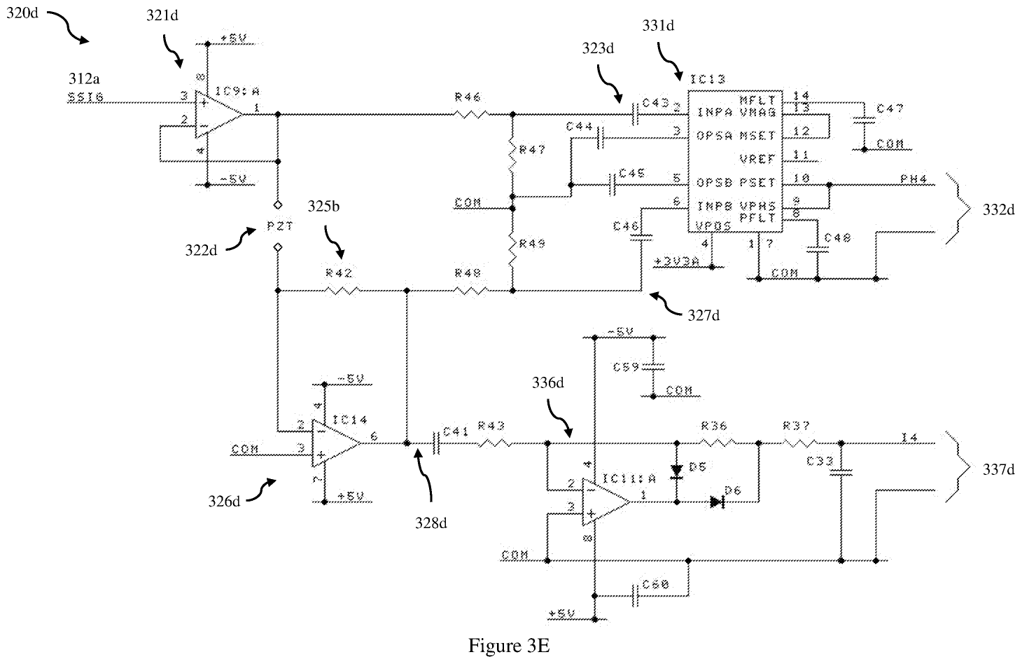

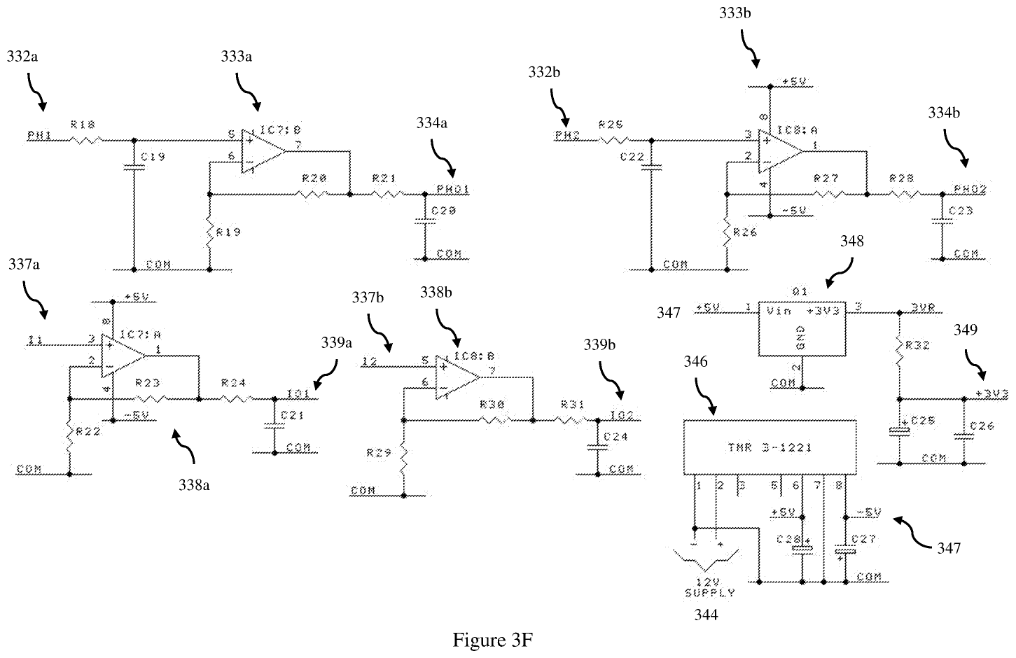

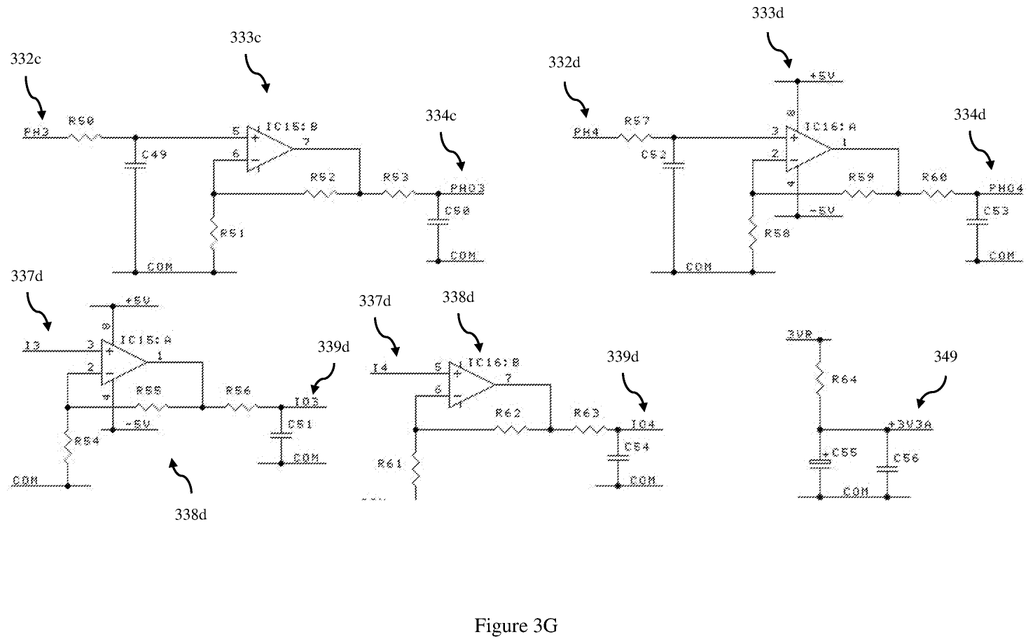

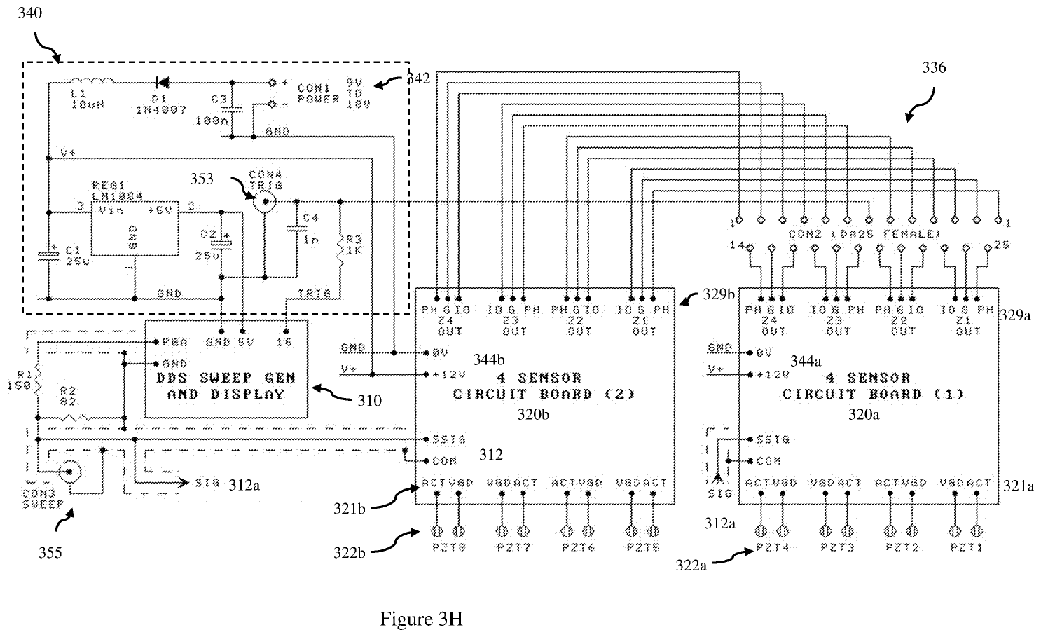

The multi-sensor impedance measuring circuit modules 220 may be provided in separate housings and wired to a central housing or they may be integrated in a single housing with the other components of the structural health monitoring circuit module 210 (an integrated module). FIG. 2 shows an embodiment in which a multi-sensor impedance measuring circuit module 220 is integrated in a single housing, and FIG. 3A is a wiring diagram showing a distributed embodiment in which a central housing houses the central components and is wired to a single multi-sensor impedance measuring circuit module 220 in a separate housing. FIG. 3H is a wiring diagram showing a distributed embodiment in which a central housing houses the central components and is wired to two single multi-sensor impedance measuring circuit module 220 each in a separate housing and connected via wires. That is in one embodiment the structural health monitoring circuit module 210 comprises one or more multi-sensor impedance measuring circuit modules 220, a power supply circuit 240, and a sweep signal generator 230. In another embodiment the structural health monitoring circuit module 210 is for connection to one or more multi-sensor impedance measuring circuit modules 220. In this embodiment one or more multi-sensor impedance measuring circuit modules comprise an input supply voltage connector and a sweep signal input connector, and the structural health monitoring circuit module provides a power supply circuit 240 and a power output connector for providing the supply voltage over a wired connector to the input voltage supply connector of the one or more multi-sensor impedance measuring circuit modules, and the sweep signal generator 230 and a sweep signal output connector for providing the AC sweep signal over a wired connector to the sweep signal input connector of the one or more multi-sensor impedance measuring circuit modules 220. The structural health monitoring circuit module 210 may also comprise a user interface 216 and a microprocessor comprising a CPU 212 and a memory 214. The microprocessor may be integrated into the user interface or be connected to the user interface 216. The user interface 216 is configured to receive one or more user input signals which are provided to the microprocessor for configuring the structural health monitoring circuit module including configuring the sweep generator circuit wherein the one or more user input signals are either received using an input device and/or a remote device. The user interface 216 may be a touch screen device, or a plurality of push buttons and a digital display, configured to allow the user to access menus and select values (e.g., frequency intervals) to configure the device.

The power supply circuit 240 comprises a voltage regulator configured to receive an unregulated voltage supply in the range of 9V to 18V (nominally 12V) and a regulated +5V. +3V and −5V supply. The unregulated voltage supply 342 may be a battery, such as a Lithium battery, although other battery technologies can be used including the use of solar panels to provide power or recharge batteries. A compact 12V lithium battery (e.g., 80 mm×30 mm−15 mm) which weighs 110 g can provide sufficient power for 24 hours monitoring. This can be extended through use of a larger battery or solar panels to allow recharging. In some embodiments a mains power supply may be used if available. In other embodiments the power supply circuit 240 could be configured to accept a wider/larger input range such as 5V to 18V, or 5 to 24V, 9 to 24V or more than 24V.

FIG. 3A shows an embodiment of a circuit in which a rectifier diode IN4007 is downstream of the unregulated voltage supply 342 connector 342, which in this embodiment is between 9V and 18V and provides a nominally 12V signal which is provided over a wire to a multi-sensor impedance measuring circuit module 320. A LM1084 linear voltage regulator which accepts input of nominally 12V and outputs +5V. +3V and −5V signal which is provided to sweep generator circuit 310 configured to generate an AC sweep signal and a trigger signal. The sweep generator circuit 310 comprises a sweep signal output connector 355 for providing the AC sweep signal over a wired connector to the multi-sensor impedance measuring circuit module 320 (or to each multiple modules as shown in FIG. 3H). A user interface 216 such as touch screen and/or input buttons may also be provided to allow a user to input one or more of a frequency range of the sweep generator circuit, and one or more monitoring parameters such as scan rate and signal level. The user interface may also allow a user to enter (or configure) one or more alert trigger conditions and one or more recipient addresses. In some embodiments the user interface is configured to receive user input signals from the DAQ 250, for example over a wired interface with the DAQ 250. In some embodiments the structural health monitoring circuit module 210 may include a communications module or interface that provides a wired or wireless interface with the communications interface 260 in the DAQ. In some embodiments the communications module 260 is used to communicate with the remote computing device 270 to allow remote configuration of the system (e.g., entering of these inputs/parameters). A combination of the two may be used allowing both local and remote configuration of the structural health monitoring circuit module 210. A microprocessor (e.g., CPU 212, RAM 214) is configured to receive user input signals for configuring the structural health monitoring circuit module including configuring the sweep generator circuit 230. In one embodiment the user input signals comprise one or more of a frequency range of the sweep generator circuit, a signal level, one or more monitoring parameters, one or more alert trigger conditions and/or one or more recipient addresses. In embodiments where a remote device 270 is used (e.g. the user interface is a remote user interface), the remote device may comprise a further local user interface to allow a user to enter the configuration parameters on the remote computing device 270 which then sends the input signals (or commands based on those input signals) to the structural health monitoring circuit module 210 (via the DAQ 250) and which processes or implements them to configure the structural health monitoring circuit module 210. The user interface 216, or DAQ CPU 252 may also be configured to send alerts and results to the remote computing device 270. and the results may be displayed by a local user interface such as display 276 on the remote computing device 270. In some embodiments, the user interface 212 is configured to receive user input commands to configure monitoring of one or more predefined groups each comprising of one or more impedance measuring circuits. In some embodiments each group comprises two or more impedance measuring circuits located on a portion of the structure to be monitored. In some embodiments each impedance measuring circuit in the group is proximal (or near) to each other to enable sectional or spatial monitoring of the structure i.e., a cluster of impedance measuring circuits/sensors. That is monitoring may be performed on selected individual sensors (group of 1), or groups or clusters of sensors. The groups may be configured using the user interface 216 (local or remote). The user interface may also be configured to allow a monitoring schedule. For example, certain groups may be monitored more often than other groups (or all sensors). The user interface 216 may provide the information to the DAQ which stores and implements the monitoring configuration via removable memory 258 of the DAQ 250.

The frequency sweep generator is a compact circuit with in this embodiment has dimensions of 85 mm×50 mm×10 mm and weighs less than 60 g. The frequency sweep generator is configured to generate an AC sweep signal with frequency in the range from 5 kHz to 1 MHz and with an RMS voltage of nominally 200 mV or less. With a touchscreen user interface 216 the dimensions are 85 mm×50 mm×30 mm with a weight of 150 g. An integrated sweep generator and touch screen module is provided for easy application of all required adjustments for a given structure's monitoring, e.g., adjusting the operational sweep frequency, the amplitude/voltage of the signal, the scan rate, etc. A memory 214 is provided to store the last setting displayed on the screen once restarting the unit. This allows for a hibernation mode, and makes it more power efficient, and the monitoring is safe against power disruptions. Additionally, the integrated sweep generator and touch screen module includes a microprocessor unit allowing programs to be written for the sweep generator operation. In one embodiment the program provides sweeping of 1000 frequency steps per second. This programme allows for targeted displays on demand and accommodation of new features.

In one embodiment the DAQ 250 further comprises a communications module 260 configured to transmit data to the remote unit 270 (or a communications interface 278 in the remote unit). The data comprises a representation of the output piezoelectric phase signal 136 and the output piezoelectric current signal 139 associated with each PZT 122. The communications module may be a wired module, for example using a wired, Ethernet, or optical fibre link or be wireless communications module that implements one or more wireless communications protocols such as Bluetooth, Wi-Fi, or a 4G/5G cellular protocol. The communications module can be used to send data files and alerts to email addresses and may use an email-SMS gateway to send SMS alerts. Data may be sent to a user computing device 270 such as a PC, mobile, tablet or to cloud server which stores data and providers a monitoring interface for multiple users. The communications module 260 may also be used to receive configuration commands to configure structural health monitoring module 210 including frequency sweep generator, report formats, frequencies and alerts trigger conditions. The microprocessor 252 and memory 254, 258, may be used to configure operation of the structural health monitoring module 210 and enable user-defined activation of user-defined sensor(s) from the whole monitoring system, user-defined pre-programmed and pre-scheduled monitoring, sectional or spatial monitoring of structure as defined and pre-scheduled by the user. The wireless sensors may be programmed to go into hibernation mode to reduce power consumption and data traffic, and to allow for a cost-effective monitoring solution. The use of wireless communications module allows remote control and interrogation, including requesting of on demand sensing and results. The sensors can periodically send summary data to a cloud server allowing continuous automated monitoring and display of data.

In one embodiment the communications module 260 in the DAQ 250 is a wireless communication module The analog to digital converter (ADC) circuit 256 in the DAQ is configured to convert each output piezoelectric phase signal and each output piezoelectric current signal into a digital representation each of which are provided to the wireless communications module 260 for transmission to a user defined destination, such as an email address or sever. The DAQ 250 comprises a processor 252 and a memory 254, both of which may be provided on a microprocessor board (e.g., a MPU), which is used to estimate the real impedance as a function of frequency which can then be displayed on a user device (e.g. display 276 of user computing device 270), or to generate a report or an alert to a user when an alert trigger condition is met, for example indicating a crack or damage to the structure and/or material. In some embodiments a removable memory 258, such as an SD card is included in DAQ module 250 and is used to store the digital representations of each output piezoelectric phase signal and each output piezoelectric current signal. This can then be stored as a file which can be sent to the user computing device 270. The removable memory may also be used as a backup storage of measurements for later downloading or transfer to the user computing device 270 by the communications module 260. The communications module may transfer the data to the remote computing apparatus 270 over a direct wired or wireless link, or the data may be transferred using intermediate devices. For example, the communications module could establish a wireless link to an access point, and then send the data to the user computing device over a network such as the internet. In some embodiments the memory is used to store the last N measurements where N is based on the available storage capacity (e.g., a rolling window) or is a predefined amount corresponding to a time window. That is a fixed amount of storage is allocated to storing the measurements, and when the allocated storage is full, the oldest record or records are overwritten to provide space for recording new measurements.

In some embodiments, the structural health monitoring module is integrated with the DAQ and comprises the analog to digital converter circuit 254 to provide the data acquisition system functionality and may also be configured to analyse the data and generate alerts and report. In this embodiment the analog to digital converter circuit 256 is configured to convert each output piezoelectric phase signal and each output piezoelectric current signal into a digital representation, and the microprocessor 252 is configured to analyse the digital representation and estimate a real impedance as a function of frequency for each sensor and send a monitoring report and/or an alert to a recipient using the wireless communication module 260. The memory 212 and/or 254 (if present) may be configured to store a recipient address, and a report format and one or more alert trigger conditions for generating an alert. The user interface 216, such as a touch screen, screen and buttons or other interface, allows a user to input one or more of a frequency range of the sweep generator circuit, one or more monitoring parameters, one or more alert trigger conditions and one or more recipient addresses. As discussed above the DAQ 250 may include a removable memory, such as an SD card may also be used to store the digital representations of each output piezoelectric phase signal and each output piezoelectric current signal either to allow removal and transfer to the user computing device 270, or as backup storage. In some embodiments, a software application executing on the user computing device 270 may be used to remotely configure the structural health monitoring module 210 and DAQ 250 module via the communications module 260.

As discussed above one or more multi sensor impedance measuring circuit module 220 may be provided which include multiple impedance measuring circuit modules 120. As noted above this may be integrated into the structural health monitoring module as shown in FIG. 2 in which there are four impedance measuring circuit modules 120 in the multi sensor impedance measuring circuit module 220 connected to four PZTs (221, 222b, 222c, 222d) located on or embedded in a structure 202.

In another embodiment the one or more multi sensor impedance measuring circuit modules 220 are provided as distributed forward deployed modules each provided in a compact weather proof housing that can be located adjacent or on to the structure to be monitored and locally wired to PZTs on or embedded in the structure. These forward deployed multi sensor impedance measuring circuit module 220 can be wired back to a central module of the structural health monitoring module 210 comprising the frequency sweep generator 230 and power supply 240 which either incorporates or is connected to the DAQ 250.

A wiring diagram of an embodiment of the multi sensor impedance measuring circuit module 320 comprising four impedance measuring circuit modules is also shown in FIG. 3A. In one embodiment the multi sensor impedance measuring circuit module 320 comprises a sweep signal input connector 312 configured to receive an input AC sweep signal 355 and a voltage converter circuit configured to generate a plurality of regulated supply voltages from an input supply voltage connector 344. In one embodiment a nominally 12V input voltage is supplied and the voltage converter circuit is configured to generate a regulated +5V supply, a −5V supply, and a +3V supply.

The sweep signal input 312 is provided as input to each of the impedance measuring circuits. A plurality of a paired input connectors 321 for connecting to an input and an output of a piezoelectric sensor 322 and each paired input connector is connected to one of (the plurality of) the impedance measuring circuit modules. A plurality of paired output connectors 329 are also provided wherein each is connected to the output of one of the impedance measuring circuit modules. The paired outputs 329 comprise the output piezoelectric phase signal 136 and the output piezoelectric current signal 139 from the respective impedance measuring circuit module 120. These may be connected directly to the data acquisition system 351 or back to the central module of the structural health monitoring module 210 that is connected to or includes the DAQ 250. The microprocessor in the DAQ 250 may be configured to generate a monitoring report or alert which can be sent to the user computing apparatus 270 via the communications module 260, for example over a wireless link 262.

It will be noted that the PZTs 222, 322 are not included within the housing of the multi sensor impedance measuring circuit module 220 but that the housing provides connectors such that wires can be run out to PZTs which are placed on or embedded in the structure to be monitored.

FIGS. 3B, 3C. 3D, and 3E, are circuit diagram of a first part of first, second, third and fourth impedance measuring modules of the first multi sensor module of FIG. 3A. FIGS. 3F is a circuit diagram of a second part of the first and second impedance measuring modules of the first multi sensor module of FIG. 3A and FIG. 3G is a circuit diagram of a second part of the third and fourth impedance measuring modules of the first multi sensor module of FIG. 3A.

Taking FIG. 3B as an example this is a more detailed circuit diagram of the embodiment shown in FIG. 1A showing major components as well as additional components (e.g., capacitors, resistors and diodes) to filter, pull up or pull down signals/input. Sweep signal 312 is provided as input to a buffer 312a (LTI362). The sweep signal 312a is also split off to the buffers 312b, 312c, 312d in the second, third and fourth circuits in FIGS. 3C to 3E.

The current to voltage converter 326a (LTI1252) is in parallel with a feedback resistor 47062 configured such that the current to voltage converter and feedback resistor receive the piezoelectric output signal from the piezoelectric sensor 322a and to generate a piezoelectric current signal 328a in which the AC voltage is proportional to both the phase angle and the current through the piezoelectric sensor. The piezoelectric current signal could alternatively be referred to as a piezoelectric voltage signal, as it is the output of the current to voltage converter. However, for the following discussion we will use piezoelectric current signal as it has a voltage proportional to the current generated by the piezoelectric sensor. The piezoelectric output signal is provided on the negative input of the LT1252 I-V converter which adjusts to a voltage that maintains an equal but opposite current through the resistor 325a to balance the PZT current. The output is split with one branch directed to a digital phase detector (AD8302) which receives the buffered sweep signal 323a on a first input and the piezoelectric current signal 327a from the current to voltage converter 326a on a second input and is configured to compare the piezoelectric current signal with the buffered sweep signal and generate a first piezoelectric phase signal (PH1). The piezoelectric current signal 328a is provided to a precision rectifier 336a comprised of an LT1364 Op Amp (the piezoelectric current signal 328a is provided to the negative input) and MM4148 diodes and resistors which are arranged to rectify the piezoelectric current signal to generate a first piezoelectric current signal I1 337A. Similar circuits are shown in FIGS. 3C to 3E.

FIG. 3F shows an embodiment of a first low pass filter 333a which receive the first piezoelectric phase signal PH1 332a and generate the output piezoelectric phase signal 334a having a DC voltage proportional to the phase difference between the buffered sweep signal and the piezoelectric current signal. The first low pass filter 333 comprises a 22 k resistor (R18) and 68 nF capacitor (C19) giving a cut-off frequency of 106 Hz and uses a TLC2272 op amp as a gain stage (with R19 and R20). The second low pass filter 338a is split between FIGS. 3A and 3E, with the RC component on FIG. 3A (22 k Resistor R37 and 68 nF capacitor C33) giving a cut-off frequency of 106 Hz, and the op amp gain stage (TLC2272 and resistors R22 and R23) on FIG. 3E. FIG. 3E shows the equivalent first and second low pass filters 333b 338b for the second circuit. FIG. 3F shows the equivalent first and second low pass filters (333c, 338c. 333d, 338d) for the third and fourth circuits.

FIG. 3E also shows the voltage converter circuit 346 comprising TMR 3-1221 DC/DC converter which takes the nominally 12V supply and generates regulated +5V and −5V supply voltages 347, and LP2950 Voltage regulator 348 which generates the regulated +3V 349 from the 5V input.

The circuits are implemented on a circuit board with a first dimension of 38 mm and a second dimension of 55 mm, and the impedance measuring circuit consumes less than 5 Watts per four PZT sensor module. Surface mounted components may be used, and the circuit may be housed within a weather proof housing.

In a further form, the impedance measuring circuit further comprises a compact small-size housing which houses a circuit board comprising a plurality of surface mounted components which implement one or more components of the multi sensor impedance measuring circuit module. In one embodiment the circuit board has a first dimension of 38 mm or less and a second dimension of 55 mm or less.

The DAQ 250 performs analysis on the output piezoelectric phase signal and output piezoelectric current signal to estimate the real component of impedance through the PZT. This may be based on the formula that Zᵣₑₐₗ=V_{cos}(θ)/I where θ is the digitised phase signal 136 and I is the digitised current signal 139, and V is a constant based on the input voltage across the PZT which can be predetermined such as by performing a measurement during calibration of the circuit. In one embodiment the components (and gains) are selected to generate output DC voltages between 0 and 5V.

The estimates of the real component of impedance can be stored with the associated sweep frequency, and these data pairs stored for all the sweep frequencies over the sweep frequency range, and then plotted or analysed using a suitable graphing or analysis package such as LabVIEW, MATLAB, R. or equivalents. The data may be stored in a file such as spreadsheet in the removable memory 258.

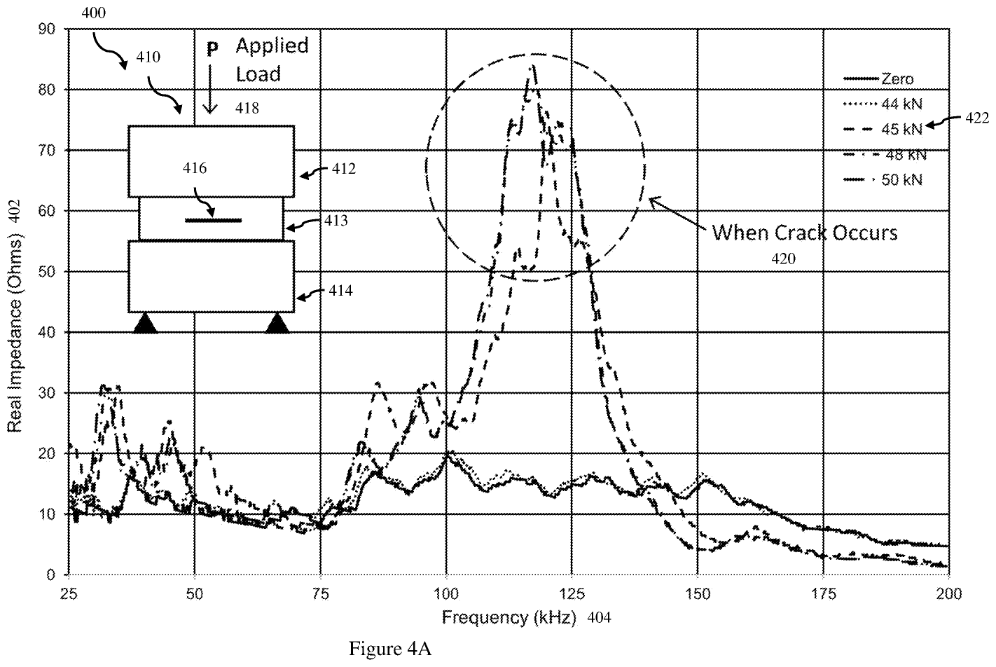

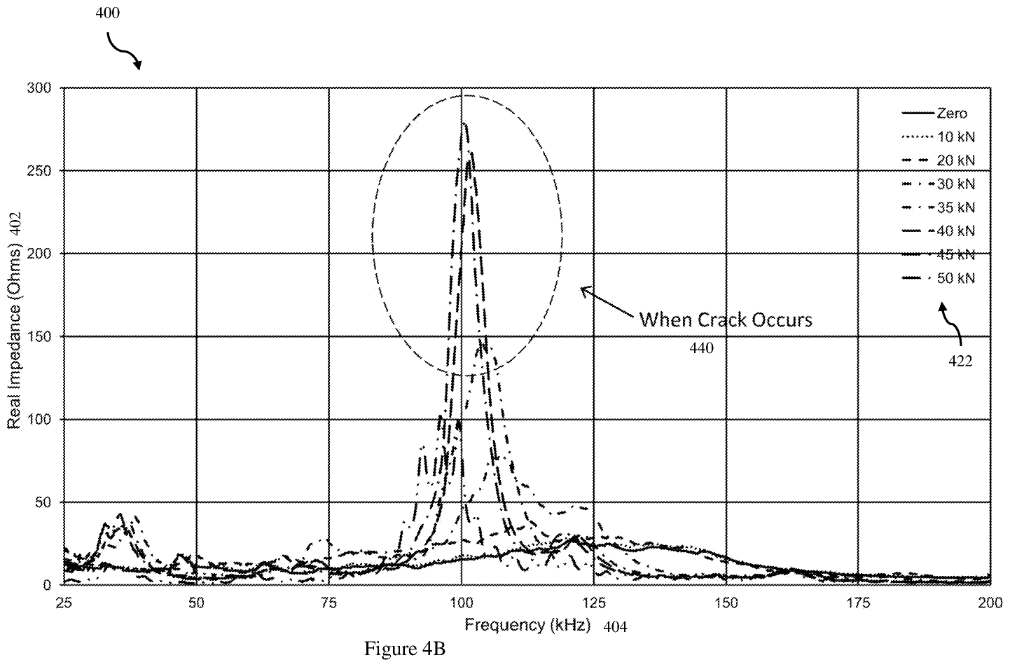

FIG. 4A is a plot 400 of the real impedance 402 as a function of frequency 404 of a piezoelectric sensor 416 embedded in a first location in a mortar joint 413 between two bricks 412 414 under a range of applied loads 422 from 0, 44, 45, 48 and 50 kN. The data was generated by an embodiment of a structural health monitoring system described above. In this embodiment there is significant increase in impedance for loads above 45 kNat around 100-125 kHz compared to lower loads indicative of a crack occurring 420. FIG. 4B is a plot 400 of the real impedance 402 as a function of frequency 404 of a second piezoelectric sensor embedded in a second location in a mortar joint between two bricks 412 414 under loads 0, 10, 20, 35, 40, 45, and 50 kNas shown in FIG. 4B. The presence of a crack 440 is indicated in the higher load above 40 kN at around 90 Hz to 110 Hz compared to the lower load signals.

These plots show that cracks can be identified by abrupt changes such as increases in impedance at a particular frequency compared to earlier recorded plots. Thus, a crack may be detected by setting alert in the case of a deviation from an average curve or a reference curve. The DAQ, or an analysis module in the remote computing device may be configured to analyse the estimates of the real component of impedance over the sweep frequency range to detect structural changes, such as cracks. This analysis may comprise detecting significant deviations at specific frequencies or over a frequency band within the sweep frequency range. One or more trigger alert conditions may be saved in memory and may comprise one or more predetermined threshold values wherein an alert is generated if the real component of impedance exceeds the predetermined threshold. Other analysis methods and alert conditions may be developed based on signal analysis of the component of impedance over the sweep frequency range, including Fourier based methods, change detection, and statistical methods configured to detect an increase in deviation compared to historical values. Alert condition triggers may be determined based on the specific signal analysis method used.

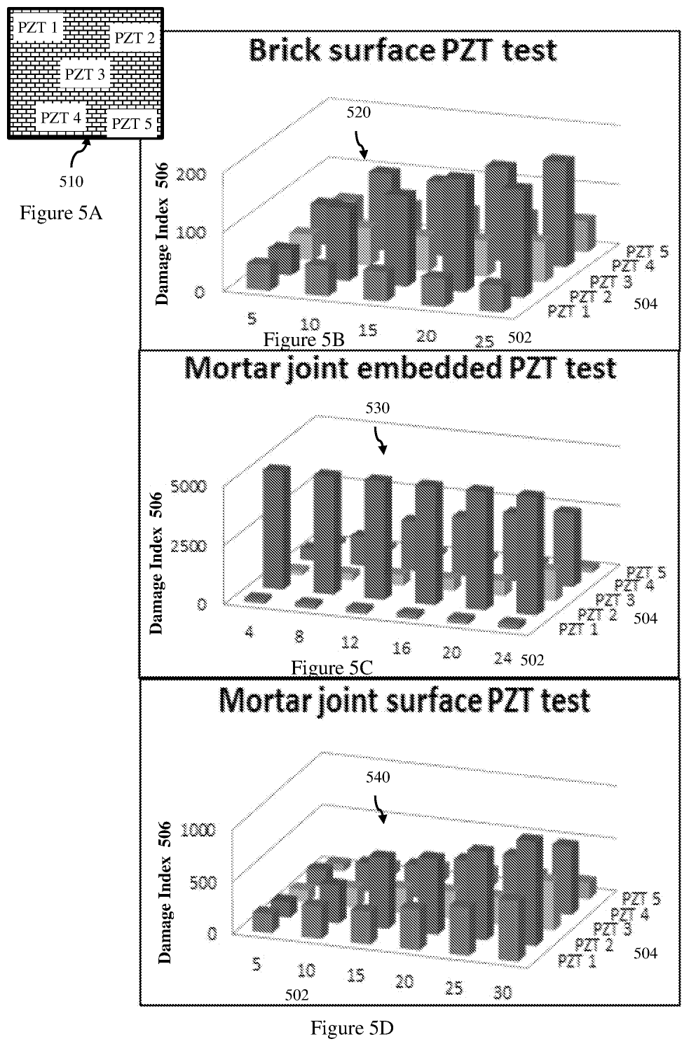

FIG. 5A is a schematic illustration of a brick wall formed of bricks and mortar joints indicating the approximate locations of five piezoelectric sensors (PZT1 to PZT 5) according to an embodiment. FIG. 5B is a bar plot of damage index as a function of increasing loads for five piezoelectric sensors located on a brick surface of the wall as illustrated in FIG. 5A. FIG. 5C is a bar plot of damage index as a function of increasing loads for five piezoelectric sensors embedded in a mortar joint in the wall as illustrated in FIG. 5A. FIG. 5D is a bar plot of damage index as a function of increasing loads for five piezoelectric sensors located on a mortar joint surface of the wall as illustrated in FIG. 5A.

These plots show that the damage index increases with load with a higher damage index recorded when a transducer is closer to a crack. Higher average damage index was observed for PZTs embedded in mortar joints. Crack initiation is earliest detected by the PZTs embedded in mortar joint and thus it was concluded that PZTs embedded in mortar joints are best for new buildings and on surface of mortar joint for existing buildings.

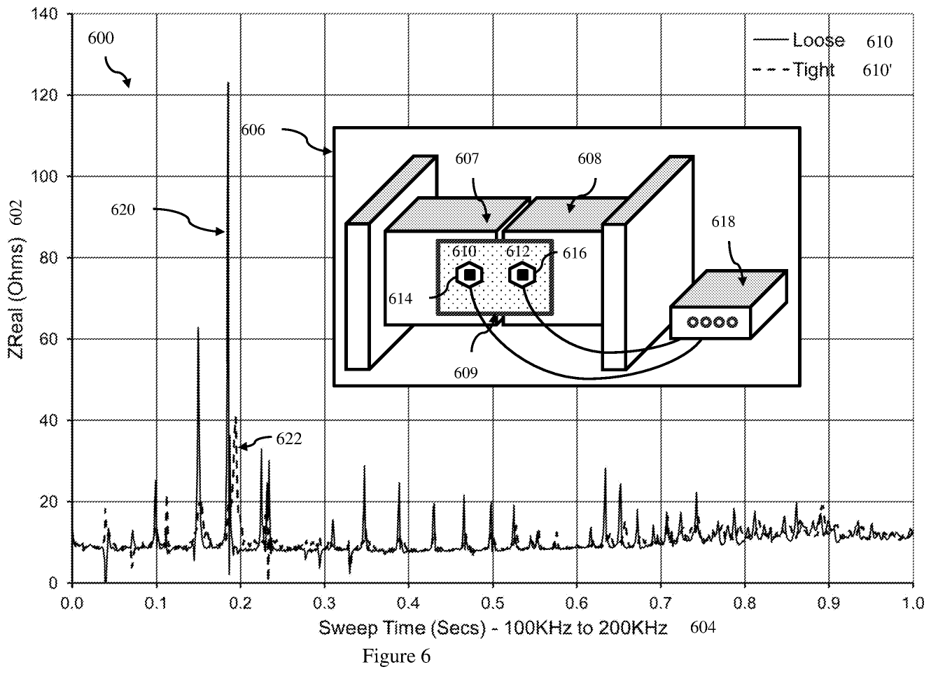

FIG. 6 is a plot 600 of the real impedance 602 as a function of frequency 604 for piezoelectric sensor located on the head of a bolt. The plots are presented for the bolt 610 when loosely screwed into a steel beam and for the same bolt when tightly screwed 610′ into the steel beam, generated by a structural health monitoring system 200 according to an embodiment. A schematic diagram of the setup 606 is also shown as inset in FIG. 6. Two beam sections 607 and 608 are fastened together via a flat plate 609 into which bolts 610 and 612 are screwed. Piezoelectric sensors 614 and 616 are attached to the heads of the bolts 610 and 612, and wired back to the structural health monitoring circuit module 210. The signal for the loose bolt 610 is shown in black and the signal in the tight bolt is shown in black dashed line 610′. In FIG. 6 it can be seen that the loose bolt has a mark large peaks 620 around 120 kHz compared to the equivalent peak 622 of the tight bolt configuration 610′.

In one embodiment the modules work over a frequency range from 5 kHz to 1 MHZ, which is a frequency range suitable for SHM applications, although a smaller or large frequency range could be used, e.g., a lower limit of 1, 10 or 20 kHz could be use, and upper limit could be 200 kHz, 500 KHz or 2MHz. The frequency range is utilisable to conduct active SHM on a wide range of materials and structures, conduct monitoring using different size PZTs and vary the size of the monitored area.

The choice of the operating range between the start and stop frequencies may be made after examination of the response from the mounted PZTs before starting each test. In some embodiments the frequency range is between 20 kHz and 400 kHz. This is a function of the size of the PZTs and the material. The module can function at frequencies up to 1 MHz.

The calibration of the real impedance value for each module is carried out by substituting the PZT with a 100 ohm resistor. When this is done, either (or both) the signal generator output or the constant in the real impedance calculation formula can be changed to obtain a 100 ohm straight line across the frequency sweep.

The phase angle versus voltage transfer function has a nonlinear section approaching zero degrees. However, this is not significant because the cosine function at angles less than 5 degrees is within 0.5 percent of unity. Therefore, at these low angles, the real part of the impedance will be within 0.5 percent of the impedance magnitude, such that after the calibration, the error of the displayed real part of the impedance is not more than 0.5 per cent.

The calibration of the phase angle voltage can be carried out by measuring the voltage at the output of the digital phase detector with a digital voltmeter, when a 10 nF capacitor is substituted for the PZT. This value was chosen because it is close to the inherent capacitance of the PZTs but is not critical. After the voltage has been measured it is multiplied by 4 and used as the denominator in the cosine calculation for that module. From a theoretical point of view, the real impedance value of the capacitor should be zero. Since capacitors are not perfect the observed values of less than a few ohms do not affect the overall results.

Embodiments of the system are compact and cost effective for widespread deployment on a wide range of structures thus providing a more useful alternative to existing systems.

Embodiments of the system may be used to monitor:
Typical steel structural connection used in bridges and various civil and industrial engineering structures;
Scaled 3D typical galvanised steel truss structure used in industrial engineering, civil engineering, truss structure types such as roof, bridge, frame, warehouse, various steel and metal structures (e.g., silo, submarine, ships, train . . . ), etc.;
Typical scaled steel and timber connection used in various structures, such as residential houses, bridges, roofs, and all the other civil, mining, petroleum (e.g., rig), mechanical (machinery and train) and geotechnical engineering, railway line structures,
Monitoring individual bolt integrity;
Monitoring torque tightness of individual bolts or a group of bolts as required;
Rockbolts and reinforced geotechnical support;
Reinforced concrete structure, such as reinforcement bars;
Conditions of rocks;
Conditions of soils;
Conditions of concrete;
Pressure vessels, submarines etc.;
Masonry structures; and/or
Machinery and various equipment components and conditions;

Embodiments of the system can be provided as compact and mobile modules using internal batteries and solar panels to provide power and wireless communications links to send data back to a user. The structural health monitoring module comprising the frequency generator is lightweight and may comprise a touch screen interface. Compact multi-sensor impedance measuring circuit modules may be forward deployed from the central module and wired back to the central module which provides power and the sweep signal. The output signals are sent to the DAQ 250 and through the communications module 260 to a user nominated destination for further analysis, processing, and display on a user computing device 270. Communication may be performed on wireless links, for example over a 4G/5G or Wi-Fi network, or via wired link. The DAQ may also perform analysis on the output signals and data may be stored locally such as on removeable storage such as an SD card.

The processing or computing devices in the structural health monitoring module 210, the DAQ. and the user computing device 270 may be configured to analyse sensor data, estimate the real impedance, detect changes, generate report and alerts and plot results. The computing apparatus may comprise a central processing unit (CPU), a memory, and an Input/Output (or Communications) interface, and may include a graphical processing unit (GPU), and input and output devices. The CPU may comprise an Arithmetic and Logic Unit (ALU) and a Control Unit and Program Counter element. The memory may comprise solid state memory and secondary storage such as a hard disk or SD Card. The Input/Output Interface may comprise a network interface and/or communications module for communicating with an equivalent communications module in another apparatus using a predefined communications protocol (e.g., Bluetooth, Zigbee, IEEE 802.15, IEEE 802.11, TCP/IP, UDP, etc). Input and output devices may be connected via wired or wireless connections. The Input/Output interface may be in communication with the storage device and save results from the analysis to the external storage device. Input and output devices may comprise a keyboard, a mouse, and a display apparatus such as a flat screen display (e.g., LCD, LED, plasma, touch screen, etc), a projector, etc. The computing devices in the structural health monitoring module 210 and the DAQ 250 may be microprocessor boards or units (MPU) comprising one or more processors and memory on a PCB board with integrated interfaces, and may include additional modules such as a wireless communications modules providing Wi-Fi and Bluetooth connectivity.

An embodiment of structural health monitoring module 210 was constructed in which the user interface 216 was a touch screen interface in the form of a TFT display module ILI9341, and the frequency sweep generator 230 was a DDS function generator module based on Analog Devices AD9833 chip. The microprocess may be an ESP32 DevKitC 32UE development module by Espressif Systems. These may be assembled on a PCB. Software was written to control operation of the touch screen using the open source Arduino IDE software, with the aid of several open source libraries. These include TFT_eSPI library by Bodner, the Arduino SPI library and the Preferences library by Volodymyr Shymanskyy.

An embodiment of a DAQ 250 was constructed in which the ADC 256 was provided by two AD7606 modules, delivering 16-bit resolution and sampling rates of up to 200 ksps. These ADC modules, with combined total of 16 channels suitable for 8 PZT sensors, are controlled by an Arduino Mega 2560 R3 microcontroller. The DAQ microprocessor was provided by a DFRobot FireBettle eESP32 Module (DFR0478) which also provides the wireless communications module 260. A real time clock module in the form of an RTC Module SD2405 was included to provide accurate real-time time keeping and date stamping functionality.

A computer program was developed for the DAQ 250 and was designed to perform several tasks using the ESP32 and ATMEGA2560 microcontrollers and various libraries. In one embodiment the program code was configured to provide the following functionality: 1) The code connects the ESP32 to a Wi-Fi network and establishes an internet connection, 2) It connects to a time server (ntp.org) to retrieve the current date and time, adjusted for the specified time zone. 3) The date and time obtained are saved to the real-time clock module. 4) The code waits for a trigger signal from a Structural Health Monitoring (SHM) module 210 (e.g., over cable 224). 5). Upon receiving the trigger signal, it sends a trigger to the ATmega2560 microcontroller to control the ADC. 6) The ATmega2560 will take the readings from the ADC 254 and send the data to ESP32. 7) The ESP32 receives the digitised piezoelectric phase and current signals from the ATmega2560. 8) The measured signals are converted to real impedance values (Zᵣₑₐₗ=V_{cos}(θ)/I). 9) The data is then saved into a text file with a filename formatted as defined by the user. 10) The data file includes a header with column descriptions for date, time, sample number, phase, current, and impedance values. 11) The code sends the data file as an email attachment to a specified recipient using an SMTP client library. 12) The code also includes the necessary library imports, pin assignments, and global variables used throughout the program. There are two separated sets of program codes uploaded to ESP32 and ATMEGA2560 respectively.

The processing or computing devices in the structural health monitoring module 210, the DAQ, and the user computing device 270 may comprise a single CPU (core) or multiple CPU's (multiple core), or multiple processors. The computing apparatus may be a server, desktop, portable computer (including tablet), a smart phone, a smart watch, or a microprocessor device incorporating a processor and on board memory and interfaces. The processor may use a parallel processor, a vector processor, or may be part of a distributed (cloud) computing apparatus. The memory is operatively coupled to the processor(s) and may comprise RAM and ROM components, and secondary storage components such as solid state disks and hard disks, which may be provided within or external to the device. The external storage device may be a directly connected external device, or a network storage device (i.e., connected over a network interface) external to the computing apparatus, including cloud based storage devices. The memory may comprise instructions to cause the processor to execute a method described herein. The memory may be used to store the operating system and additional software modules or instructions. The processor(s) may be configured to load and execute the software modules or instructions stored in the memory. The computing apparatus may be configured to continuously analyse input sensor signals and may be configured to generate reports or alarms if variations are detected. For example, the computing device may store a set of rules or thresholds indicative of variations against which the results of the analysis can be compared (e.g., deviations from reference curves or spectrums). The microprocessors used in the modules may be microcontrollers such as Arduino microcontrollers and include on-board memory.

Those of skill in the art would understand that information and signals may be represented using any of a variety of technologies and techniques. For example, data, instructions, commands, information, signals, bits, symbols, and chips may be referenced throughout the above description, may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software or instructions, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. Software modules, also known as computer programs, computer codes, or instructions, may contain a number of source code or object code segments or instructions, and may reside in any computer readable medium such as a RAM memory, flash memory, ROM memory, EPROM memory, registers, hard disk, a removable disk, a CD-ROM, a DVD-ROM, a Blu-ray disc, or any other form of computer readable medium. In some aspects the computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media. In another aspect, the computer readable medium may be integral to the processor. The processor and the computer readable medium may reside in an ASIC or related device. The software codes may be stored in a memory unit and the processor may be configured to execute them. The memory unit may be implemented within the processor or external to the processor, in which case it can be communicatively coupled to the processor via various means as is known in the art.

Further, it should be appreciated that modules and/or other appropriate means for performing the methods and techniques described herein can be downloaded and/or otherwise obtained by computing device. For example, such a device can be coupled to a server to facilitate the transfer of means for performing the methods described herein. Alternatively, various methods described herein can be provided via storage means (e.g., RAM, ROM, a physical storage medium such as a compact disc (CD) or USB storage drive, etc.), such that a computing device can obtain the various methods upon coupling or providing the storage means to the device. Moreover, any other suitable technique for providing the methods and techniques described herein to a device can be utilized.

In one form the invention may comprise a computer program product for performing the method or operations presented herein. For example, such a computer program product may comprise a computer (or processor) readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, the terms “determining”, “obtaining” and “estimating” encompasses a wide variety of actions. For example, “determining”, “obtaining” and “estimating” may include calculating, computing, processing, deriving, investigating, looking up (e.g., looking up in a table, a database or another data structure), ascertaining and the like. Also, “determining”, and “obtaining” may include receiving (e.g., receiving information), accessing (e.g., accessing data in a memory) and the like. Also, “determining”, “obtaining” and “estimating” may include resolving, selecting, choosing, establishing and the like.

The reference to any prior art in this specification is not, and should not be taken as, an acknowledgement or any form of suggestion that such prior art forms part of the common general knowledge.

It will be understood that the terms “comprise” and “include” and any of their derivatives (e.g., comprises, comprising, includes, including) as used in this specification, and the claims that follow, is to be taken to be inclusive of features to which the term refers, and is not meant to exclude the presence of any additional features unless otherwise stated or implied.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

1. An impedance measuring circuit comprising:
a buffer configured to receive an Alternating Current (AC) sweep signal from a frequency sweep generator and provide the buffered sweep signal to an input of a piezoelectric sensor;
a current to voltage converter in parallel with a feedback resistor configured such that the current to voltage converter and feedback resistor receive a piezoelectric output signal from the piezoelectric sensor and to generate a piezoelectric current signal in which the AC voltage is proportional to both the phase angle and the current through the piezoelectric sensor;
a phase comparison circuit which receives the buffered sweep signal on a first input and the piezoelectric current signal on a second input and is configured to compare the piezoelectric current signal with the buffered sweep signal and generates an output piezoelectric phase signal having a Direct Current (DC) voltage proportional to the phase difference between the buffered sweep signal and the piezoelectric current signal; and
a rectifier circuit which receives the piezoelectric current signal on a first input and is configured to generate an output piezoelectric current signal having a DC voltage proportional to the current through the piezoelectric sensor.

2. The impedance measuring circuit as claimed in claim 1, wherein:
the phase comparison circuit comprises:
a digital phase detector which receives the buffered sweep signal on a first input and the piezoelectric current signal from the current to voltage converter on a second input and is configured to compare the piezoelectric current signal with the buffered sweep signal and generate a first piezoelectric phase signal; and
a first low pass filter configured to receive the first piezoelectric phase signal and generate the output piezoelectric phase signal having a DC voltage proportional to the phase difference between the buffered sweep signal and the piezoelectric current signal; and
the rectifier circuit comprises:
a rectifier configured to receive the piezoelectric current signal on a first input and rectify the piezoelectric current signal to generate a first piezoelectric current signal; and
a second low pass filter configured to receive the first piezoelectric current signal and generate the output piezoelectric current signal having a DC voltage proportional to the current through the piezoelectric sensor.

3. The impedance measuring circuit as claimed in claim 1 wherein the AC sweep signal has a frequency in the range from 5 kHz to 1 MHz and the components of the circuit are configured to operate over the frequency range from 5 kHz to 1 MHz.

4. The impedance measuring circuit as claimed in claim 1, wherein the output piezoelectric phase signal and the output piezoelectric current signal are DC signals with a voltage in the range of 0 to 5V.

5. The impedance measuring circuit as claimed in claim 1, wherein the impedance measuring circuit consumes less than 5 Watts of power.

6. A multi sensor impedance measuring circuit module comprising:
a sweep signal input connector configured to receive an input AC sweep signal or a sweep generator circuit configured to generate an AC sweep signal;
a voltage converter circuit configured to generate a plurality of regulated supply voltages from an input supply voltage connector or a power supply circuit;
a plurality of impedance measuring circuit modules as claimed in claim 1 wherein the sweep signal input is provided as input to each of the impedance measuring circuits;
a plurality of a paired input connectors for connecting to an input and an output of a piezoelectric sensor wherein each paired input connectors are connected to one of the plurality of impedance measuring circuit modules; and
a plurality of paired output connectors each connected to the output of one of the impedance measuring circuit modules wherein the paired outputs comprises the output piezoelectric phase signal and the output piezoelectric current signal from the respective impedance measuring circuit module.

7. The impedance measuring circuit as claimed in claim 6 wherein the voltage converter circuit is configured to generate a regulated +5V supply, a −5V supply, and a +3V supply.

8. The impedance measuring circuit as claimed in claim 6, further comprising a compact single-unit housing which houses the circuit board comprising a plurality of surface mounted components which implement one or more components of the multi sensor impedance measuring circuit module.

9. A structural health monitoring circuit module for use in a structural health monitoring system comprising:
one or more multi-sensor impedance measuring circuit modules as claimed in claim 6, wherein the one or more multi-sensor impedance measuring circuit modules comprises the power supply circuit and the sweep signal generator wherein the power supply circuit comprises a voltage regulator configured to receive an unregulated voltage supply in the range of 9V to 18V and a regulated +5V, −5V and +3V supply; and
a user interface, at least one processor and at least one memory, wherein the user interface is configured to receive one or more user input signals which are provided to the at least one of the at least one processor for configuring the structural health monitoring circuit module including configuring the sweep generator circuit wherein the one or more user input signals are either received using an input device and/or from a remote device.

10. A structural health monitoring circuit module for use in a structural health monitoring system and for connecting to one or more multi-sensor impedance measuring circuit modules as claimed in claim 6 wherein the one or more multi-sensor impedance measuring circuit modules comprise the input supply voltage connector and the sweep signal input connector, and the structural health monitoring circuit module comprising:
a power supply circuit comprising a voltage regulator configured to receive an unregulated voltage supply in the range of 9V to 18V and a regulated +5V, −5V and +3V supply;
a power output connector for providing the unregulated voltage supply over a wired connector to the input voltage supply connector of the one or more multi-sensor impedance measuring circuit modules;
a sweep generator circuit configured to generate the AC sweep signal;
a sweep signal output connector for providing the AC sweep signal over a wired connector to the sweep signal input connector of the one or more multi-sensor impedance measuring circuit modules; and
a user interface, at least one processor and at least one memory wherein the user interface is configured to receive one or more user input signals which are provided to at least one of the at least one processors for configuring the structural health monitoring circuit module including configuring the sweep generator circuit wherein the one or more user input signals are either received using an input device and/or a remote device.

11. The structural health monitoring circuit module as claimed in claim 9 wherein the AC sweep signal has a frequency in the range from 5 kHz to 1 MHz.

12. The structural health monitoring circuit module as claimed in claim 9 wherein AC sweep signal has an RMS voltage of 200 mV or less.

13. The structural health monitoring circuit module as claimed in claim 9 wherein the sweep generator circuit further comprises a sweep trigger signal.

14. The structural health monitoring module as claimed in claim 13 further comprising an analog to digital converter circuit configured to convert each output piezoelectric phase signal and each output piezoelectric current signal from each of the one or more multi-sensor impedance measuring circuit modules into a digital representation comprised of a digitised phase signal and a digitised current signal, wherein the one or more processors are configured to analyse the digital representations and estimate a real impedance as a function of frequency for each sensor and generate and store a monitoring report in the at least one memory, and a communications module configured to allow sending or downloading of a stored monitoring report.

15. The structural health monitoring module as claimed in claim 14, wherein the at least one memory is configured to store a recipient address, and one or more alert trigger conditions for generating an alert, and the one or more processors are configured to analyse the digitised phase signal and the digitised current signal for each of the one or more multi-sensor impedance measuring circuit modules to determine if one or more of the one or more alert trigger conditions are satisfied, and the communications module is a wireless communications module configured to send the monitoring report to a recipient address and/or an alert to a recipient if one or more of the one or more alert trigger conditions are satisfied.

16. The structural health monitoring module as claimed in claim 14, wherein one or more user input signals are received from the remote device via the communications module, or from the user interface and the one or more user input signals comprises one or more of a frequency range of the sweep generator circuit, a signal level, one or more monitoring parameters, one or more alert trigger conditions and/or one or more recipient addresses.

17. The structural health monitoring module as claimed in claim 16 wherein the one or more monitoring parameters are used to configure the one or more processors to monitor a predefined group of one or more impedance measuring circuits.

18. The structural health monitoring module as claimed in claim 14 wherein analysing the digitised phase signal and the digitised current signal for each of the one or more multi-sensor impedance measuring circuit modules comprises estimating a real impedance, Zᵣₑₐₗ=V_{cos}(θ)/I where θ is the respective digitised phase signal and I is the respective digitised current signal, and V is a predetermined constant obtained from a calibration measurement comprising measuring an input voltage across the respective piezoelectric sensor.

19. A structural health monitoring system comprising:
a structural health monitoring circuit module as claimed in claim 10;
one or more multi-sensor impedance measuring circuit modules as claimed in claim 6; and
a data acquisition module comprising an analog to digital converter circuit, at least one processor, at least one memory and a communications module, wherein the analog to digital converter circuit is configured to convert each output piezoelectric phase signal and each output piezoelectric current signal from each of the one or more multi-sensor impedance measuring circuit modules into a digital representation comprised of a digitised phase signal and a digitised current signal, and the at least one processor is configured to analyse the digital representations estimate a real impedance as a function of frequency for each sensor and generate and store a monitoring report in the at least one memory, and the communications module is configured to allow sending or downloading of the stored monitoring report.

20. The system as claimed in claim 19, wherein the at least one memory is configured to store a recipient address, and one or more alert trigger conditions for generating an alert, and the one or more processors are configured to analyse the digitised phase signal and the digitised current signal for each of the one or more multi-sensor impedance measuring circuit modules to determine if one or more of the one or more alert trigger conditions are satisfied, and the communications module is a wireless communications module configured to send the monitoring report to a recipient address and/or an alert to a recipient if one or more of the one or more alert trigger conditions are satisfied.

21. The system as claimed in claim 19, wherein one or more user input signals are received from the remote device via the communications module or from the user interface, and the one or more user input signals comprises one or more of a frequency range of the sweep generator circuit, a signal level, one or more monitoring parameters, one or more alert trigger conditions and/or one or more recipient addresses.

22. The system as claimed in claim 21 wherein the one or more monitoring parameters are used to configure the one or more processors to monitor a predefined group of one or more impedance measuring circuits.

23. The system as claimed in claim 20 wherein analysing the digitised phase signal and the digitised current signal for each of the one or more multi-sensor impedance measuring circuit modules comprises estimating a real impedance, Zᵣₑₐₗ=V_{cos}(θ)/I where θ is the respective digitised phase signal and I is the respective digitised current signal, and V is a predetermined constant obtained from a calibration measurement comprising measuring an input voltage across the respective piezoelectric sensor.

24. A method for measuring the impedance of a piezoelectric sensor, comprising:
buffering an Alternating Current (AC) sweep signal received from a frequency sweep generator and providing the buffered sweep signal to an input of a piezoelectric sensor;
generating a piezoelectric current signal in which the AC voltage is proportional to both the phase angle and the current through the piezoelectric sensor using a current to voltage converter in parallel with a feedback resistor configured such that the current to voltage converter and feedback resistor receive a piezoelectric output signal from the piezoelectric sensor;
generating an output piezoelectric phase signal having a Direct Current (DC) voltage proportional to the phase difference between the buffered sweep signal and the piezoelectric current signal using a phase comparison circuit which receives the buffered sweep signal on a first input and the piezoelectric current signal on a second input and is configured to compare the piezoelectric current signal with the buffered sweep signal; and
generating an output piezoelectric current signal having a DC voltage proportional to the current through the piezoelectric sensor using a rectifier circuit which receives the piezoelectric current signal on a first input.

25. The method as claimed in claim 24 further comprising digitising the output piezoelectric phase signal to obtain a digitised phase signal θ and digitising the output piezoelectric current signal to obtain a digitised current signal I, and estimating a real impedance, Zᵣₑₐₗ=V_{cos}(θ)/I where V is a predetermined constant obtained from a calibration measurement comprising measuring an input voltage across the piezoelectric sensor.

26. The structural health monitoring circuit module as claimed in claim 10 wherein the sweep generator circuit further comprises a sweep trigger signal.

27. The structural health monitoring module as claimed in claim 26 further comprising an analog to digital converter circuit configured to convert each output piezoelectric phase signal and each output piezoelectric current signal from each of the one or more multi-sensor impedance measuring circuit modules into a digital representation comprised of a digitised phase signal and a digitised current signal, wherein the one or more processors are configured to analyse the digital representations and estimate a real impedance as a function of frequency for each sensor and generate and store a monitoring report in the at least one memory, and a communications module configured to allow sending or downloading of a stored monitoring report.

28. The structural health monitoring module as claimed in claim 27 wherein analysing the digitised phase signal and the digitised current signal for each of the one or more multi-sensor impedance measuring circuit modules comprises estimating a real impedance, Zᵣₑₐₗ=V_{cos}(θ)/I where θ is the respective digitised phase signal and I is the respective digitised current signal, and V is a predetermined constant obtained from a calibration measurement comprising measuring an input voltage across the respective piezoelectric sensor.
